(19) United States
(12) Patent Application Publication
(10) Pub. No.: US 2026/0025713 A1
(43) Pub. Date: Jan. 22, 2026

(54) METHOD AND APPARATUS FOR TRANSMITTING AND RECEIVING DATA, AND COMMUNICATION SYSTEM

(71) Applicant: FUJITSU LIMITED, Kawasaki-shi (JP)

(72) Inventors: Guorong LI, Beijing (CN); Meiyi JIA, Beijing (CN); Su YI, Beijing (CN); Xin WANG, Beijing (CN)

(73) Assignee: FUJITSU LIMITED, Kawasaki-shi (JP)

(21) Appl. No.: 19/344,751

(22) Filed: Sep. 30, 2025

Related U.S. Application Data
(63) Continuation of application No. PCT/CN2023/086316, filed on Apr. 4, 2023.

(51) Int. Cl. H04W 28/18; H04W 76/15

(52) U.S. Cl. CPC H04W 28/18; H04W 76/15

(57) ABSTRACT

An apparatus for receiving and transmitting data, configured in a relay terminal equipment, includes: a receiver configured to receive a first data packet transmitted by a source terminal equipment to a destination terminal equipment, the first data packet comprising data transmitted by the source terminal equipment to the destination terminal equipment; processor circuitry configured to determine a first egress RLC (Radio Link Control) channel according to mapping relationship of radio bearers (RBs) and egress RLC channels for a pair of the source terminal equipment and the destination terminal equipment configured by a first configuration information, wherein the first configuration information comprising an identifier of the source terminal equipment, an identifier of the destination terminal equipment, and mapping relationship information of radio bearers (RBs) and egress RLC channels corresponding to the pair of the source terminal equipment and the destination terminal equipment; and a transmitter.

### CROSS-REFERENCE TO RELATED APPLICATION

This application is a continuation application under 35 U.S.C. 111 (a) of International Patent Application PCT/CN2023/086316 filed on Apr. 4, 2023, and designated the U.S., the entire contents of which are incorporated herein by reference.

### FIELD

Embodiments of the present disclosure relate to the field of wireless communication technologies.

### BACKGROUND

New technologies are introduced in a standardization process of the 5th Generation Mobile Communication Technology (5G) of the 3rd Generation Partnership Project (3GPP), allowing a user equipment (UE) to directly discover and/or communicate with each other using a sidelink or sidelink (SL) communication technology, in which the sidelink interface may further be called a PC5 interface. For example, vehicle-to-everything (V2X) communication, public safety (PS) communication, direct file transfer between user equipments, etc., may rely on communication on the sidelink interface.

UE-to-UE relay (U2U relay) from a user equipment (UE) to a user equipment (UE) is being studied in Release 18, in which the UE-to-UE relay refers to that “a source user equipment (source UE)” and “a destination user equipment (destination UE)” (which may called “a source remote user equipment (source remote UE)” and “a destination remote user equipment (destination remote UE)”, or “a source UE” and “a destination UE” are collectively called “a remote user equipment (remote UE)”) communicate via “a relay user equipment (relay UE)”, the source UE and the relay UE communicate using a sidelink, the relay UE and the destination UE communicate using a sidelink, thereby effectively expanding a cover range of sidelink transmission between the source UE and the destination UE and saving transmission power of the remote UE.

It should be noted that the above introduction to the technical background is just to facilitate a clear and complete description of the technical solutions of the present disclosure, and is elaborated to facilitate understanding of persons skilled in the art. It cannot be considered that these technical solutions are known by persons skilled in the art just because these solutions are elaborated in the Background of the present disclosure.

### SUMMARY

In the study of U2U relay in Release 18, it is agreed to use a user plane protocol stack and a control plane protocol stack which introduce an adaptation (ADAPT) layer, the adaptation layer may further be called an SRAP (Sidelink Relay Adaptation Protocol) layer.

Inventor finds that for the U2U relay, whether to support the multiplexing of data from different destination terminal equipments (destination UEs) to the same RLC channel and how to perform data transmission are problems that need to be solved.

To solve at least one of the above problems or other similar problems, the embodiments of the present disclosure provide a method and an apparatus for receiving and transmitting data, a method and an apparatus for transmitting data, and a communication system.

According to one aspect of the embodiments of the present disclosure, an apparatus for receiving and transmitting data is provided, configured in a relay terminal equipment, the apparatus including:
a receiving unit configured to receive a first data packet transmitted by a source terminal equipment to a destination terminal equipment, the first data packet including data transmitted by the source terminal equipment to the destination terminal equipment;
a first determining unit configured to determine a first egress RLC channel to which the destination terminal equipment corresponds, wherein first egress RLC channels to which different destination terminal equipments correspond are different; and
a transmitting unit configured to transmit a second data packet to the destination terminal equipment via the determined first egress RLC channel, the second data packet including the data.

According to another aspect of the embodiments of the present disclosure, a method for receiving and transmitting data is provided, applicable to a relay terminal equipment, the method including:
receiving a first data packet transmitted by a source terminal equipment to a destination terminal equipment, the first data packet including data transmitted by the source terminal equipment to the destination terminal equipment;
determining a first egress RLC channel to which the destination terminal equipment corresponds, wherein first egress RLC channels to which different destination terminal equipments correspond are different; and
transmitting a second data packet to the destination terminal equipment via the determined first egress RLC channel, the second data packet including the data.

According to another aspect of the embodiments of the present disclosure, a terminal equipment is provided, including a memory and a processor, the memory storing a computer program, the processor being configured to execute the computer program to implement the method for receiving and transmitting data at a relay terminal equipment side.

According to another aspect of the embodiments of the present disclosure, an apparatus for transmitting data is provided, configured in a source terminal equipment, the apparatus including:
a determining unit configured to determine a second egress RLC channel to which a destination terminal equipment corresponds, wherein different destination terminal equipments correspond to the same second egress RLC channel; and
a transmitting unit configured to transmit via the determined second egress RLC channel to a relay terminal equipment, a data packet that is transmitted by the source terminal equipment to different destination terminal equipments, the data packet including data transmitted by the source terminal equipment to the destination terminal equipment.

According to another aspect of the embodiments of the present disclosure, a method for transmitting data is provided, applicable to a source terminal equipment, the method including:
determining a second egress RLC channel to which a destination terminal equipment corresponds, wherein different destination terminal equipments correspond to the same second egress RLC channel; and
transmitting via the determined second egress RLC channel to a relay terminal equipment, a data packet that is transmitted by the source terminal equipment to different destination terminal equipments, the data packet including data transmitted by the source terminal equipment to the destination terminal equipment.

According to another aspect of the embodiments of the present disclosure, an apparatus for transmitting data is provided, configured in a source terminal equipment, the apparatus including:
a determining unit configured to determine a third egress RLC channel to which a destination terminal equipment corresponds, wherein different destination terminal equipments correspond to different third egress RLC channels; and
a transmitting unit configured to transmit via the determined third egress RLC channel to a relay terminal equipment, a data packet that is transmitted by the source terminal equipment to the destination terminal equipment,
wherein the data packet includes data transmitted by the source terminal equipment to the destination terminal equipment and a radio bearer identifier, but does not include an identifier able to be mapped to the destination terminal equipment.

According to another aspect of the embodiments of the present disclosure, a method for transmitting data is provided, applicable to a source terminal equipment, the method including:
determining a third egress RLC channel to which a destination terminal equipment corresponds, wherein different destination terminal equipments correspond to different third egress RLC channels; and
transmitting via the determined third egress RLC channel to a relay terminal equipment, a data packet that is transmitted by the source terminal equipment to the destination terminal equipment,
wherein the data packet includes data transmitted by the source terminal equipment to the destination terminal equipment and a radio bearer identifier, but does not include an identifier able to be mapped to the destination terminal equipment.

According to another aspect of the embodiments of the present disclosure, a terminal equipment is provided, including a memory and a processor, the memory storing a computer program, the processor being configured to execute the computer program to implement the method for transmitting data at a source terminal equipment side.

According to a further aspect of the embodiments of the present disclosure, a communication system is provided, including:
a source terminal equipment configured to execute the method for transmitting data at a source terminal equipment side;
a relay terminal equipment configured to execute the method for receiving and transmitting data at a relay terminal equipment side; and
a destination terminal equipment configured to receive a data packet transmitted by the relay terminal equipment.

Advantageous effect of the embodiments of the present disclosure lies in: different destination terminal equipments correspond to different egress RLC channels, a relay equipment is able to determine an egress RLC channel to which the determination terminal equipment corresponds, and transmit received data to a corresponding determination terminal equipment according to a determined egress RLC channel; hence, in the case of supporting and not supporting the multiplexing of data from different destination terminal equipments to the same RLC channel, it is capable of transmitting received data to corresponding destination terminal equipments, which solves said problems existing in related arts.

Referring to the later description and drawings, specific implementations of the present disclosure are disclosed in detail, indicating a mode that the principle of the present disclosure may be adopted. It should be understood that the implementations of the present disclosure are not limited in terms of a scope. Within the scope of the terms of the attached claims, the implementations of the present disclosure include many changes, modifications and equivalents.

Features that are described and/or shown for one implementation may be used in the same way or in a similar way in one or more other implementations, may be combined with or replace features in the other implementations.

It should be emphasized that the term “comprise/include” when being used herein refers to presence of a feature, a whole piece, a step or a component, but does not exclude presence or addition of one or more other features, whole pieces, steps or components.

### BRIEF DESCRIPTION OF THE DRAWINGS

An element and a feature described in a drawing or an implementation of the embodiments of the present disclosure may be combined with an element and a feature shown in one or more other drawings or implementations. In addition, in the drawings, similar labels represent corresponding components in several drawings and may be used to indicate corresponding components used in more than one implementation.

The included drawings are used to provide a further understanding on the embodiments of the present disclosure, constitute a part of the Specification, are used to illustrate the implementations of the present disclosure, and expound the principle of the present disclosure together with the text description. Obviously, the drawings in the following description are only some embodiments of the present disclosure. Persons skilled in the art may further obtain other drawings according to these drawings under the premise that they do not pay inventive labor. In the drawings:

FIG. 1 is a schematic diagram of a system protocol stack architecture in the embodiments of the present disclosure;

FIG. 2 is a schematic diagram of scenarios in the embodiments of the present application;

FIG. 3 is a schematic diagram of a method for receiving and transmitting data in the embodiments of the present disclosure;

FIG. 4 is a schematic diagram of a method for receiving and transmitting data in the embodiments of the present disclosure;

FIG. 5 is a schematic diagram of a method for transmitting data in the embodiments of the present disclosure;

FIG. 6 is a schematic diagram of a method for transmitting data in the embodiments of the present disclosure;

FIG. 7 is a schematic diagram of a method for receiving data in the embodiments of the present disclosure;

FIG. 8 is an example diagram of data transmission and reception in the embodiments of the present disclosure;

FIG. 9 is a schematic diagram of a system protocol stack architecture in the embodiments of the present disclosure;

FIG. 10 is another example diagram of data transmission and reception in the embodiments of the present disclosure;

FIG. 11 is a schematic diagram of a system protocol stack architecture in the embodiments of the present disclosure;

FIG. 12 is a schematic diagram of an apparatus for receiving and transmitting data in the embodiments of the present disclosure;

FIG. 13 is another schematic diagram of an apparatus for receiving and transmitting data in the embodiments of the present disclosure;

FIG. 14 is a schematic diagram of an apparatus for transmitting data in the embodiments of the present disclosure;

FIG. 15 is a schematic diagram of an apparatus for transmitting data in the embodiments of the present disclosure;

FIG. 16 is another schematic diagram of an apparatus for receiving data in the embodiments of the present disclosure; and

FIG. 17 is a schematic diagram of composition of a terminal equipment in embodiments of the present disclosure.

### DETAILED DESCRIPTION

Referring to the drawings, through the following Specification, the aforementioned and other features of the present disclosure will become obvious. The Specification and the drawings specifically disclose particular implementations of the present disclosure, showing partial implementations which may adopt the principle of the present disclosure. It should be understood that the present disclosure is not limited to the described implementations, on the contrary, the present disclosure includes all the modifications, variations and equivalents falling within the scope of the attached claims. Various implementations of the present disclosure will be described below with reference to the drawings. These implementations are exemplary only and are not limitations to the present disclosure.

In the embodiments of the present disclosure, the term “first” and “second”, etc. are used to distinguish different elements in terms of appellation, but do not represent a spatial arrangement or time sequence, etc. of these elements, and these elements should not be limited by these terms. The term “and/or” includes any and all combinations of one or more of the associated listed terms. The terms “include”, “comprise” and “have”, etc. refer to the presence of stated features, elements, members or components, but do not preclude the presence or addition of one or more other features, elements, members or components.

In the embodiments of the present disclosure, the singular forms “a/an” and “the”, etc. include plural forms, and should be understood broadly as “a kind of” or “a type of”, but are not defined as the meaning of “one”; in addition, the term “the” should be understood to include both the singular forms and the plural forms, unless the context clearly indicates otherwise. In addition, the term “according to” should be understood as “at least partially according to . . . ”, the term “based on” should be understood as “at least partially based on . . . ”, unless the context clearly indicates otherwise.

In the embodiments of the present disclosure, the term “a communication network” or “a wireless communication network” may refer to a network that meets any of the following communication standards, such as Long Term Evolution (LTE), LTE-Advanced (LTE-A), Wideband Code Division Multiple Access (WCDMA), High-Speed Packet Access (HSPA) and so on.

And, communication between devices in a communication system may be carried out according to a communication protocol at any stage, for example may include but be not limited to the following communication protocols: 1G (generation), 2G, 2.5G, 2.75G, 3G, 4G, 4.5G, and future 5G, New Radio (NR) and so on, and/or other communication protocols that are currently known or will be developed in the future.

In the embodiments of the present disclosure, the term “a network device” refers to, for example, a device that accesses a terminal equipment in a communication system to a communication network and provides services to the terminal equipment. The network device may include but be not limited to the following devices: a Base Station (BS), an Access Point (AP), a Transmission Reception Point (TRP), a broadcast transmitter, a Mobile Management Entity (MME), a gateway, a server, a Radio Network Controller (RNC), a Base Station Controller (BSC) and so on.

The base station may include but be not limited to: a node B (NodeB or NB), an evolution node B (eNodeB or eNB) and a 5G base station (gNB), etc., and may further includes a Remote Radio Head (RRH), a Remote Radio Unit (RRU), a relay or a low power node (such as femto, pico, etc.). And the term “base station” may include their some or all functions, each base station may provide communication coverage to a specific geographic region. The term “cell” may refer to a BS and/or its coverage area, which depends on the context in which this term is used.

In the embodiments of the present disclosure, the term “User Equipment (UE)” or “Terminal Equipment (TE)” refers to, for example, a device that accesses a communication network and receives network services through a network device. The user equipment may be fixed or mobile, and may also be referred to as Mobile Station (MS), a terminal, Subscriber Station (SS), Access Terminal (AT) and a station and so on.

The user equipment may include but be not limited to the following devices: a Cellular Phone, a Personal Digital Assistant (PDA), a wireless modem, a wireless communication device, a handheld device, a machine-type communication device, a laptop computer, a cordless phone, a smart phone, a smart watch, a digital camera and so on.

For another example, under a scenario such as Internet of Things (IoT), the user equipment may also be a machine or apparatus for monitoring or measurement, for example may include but be not limited to: a Machine Type Communication (MTC) terminal, a vehicle-mounted communication terminal, a Device to Device (D2D) terminal, a Machine to Machine (M2M) terminal, a terminal that supports sidelink communication, and so on.

Moreover, the term “a network side” or “a network device side” refers to a side of a network, may be a base station, and may include one or more network devices as described above. The term “a user side” or “a terminal side” or “a terminal equipment side” refers to a side of a user or terminal, may be a UE, and may include one or more terminal equipments as described above. If it is not specifically mentioned herein, “a device” may refer to a network device, or may refer to a terminal equipment.

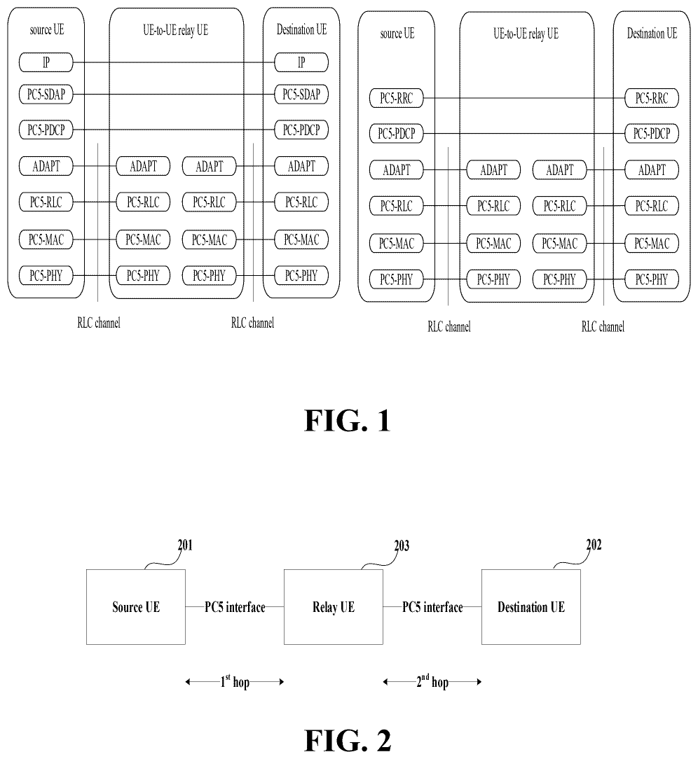

FIG. 1 is a schematic diagram of a system protocol stack architecture in the embodiments of the present disclosure, including a user plane protocol stack diagram (as shown in the left figure of FIG. 1) and a control plane protocol stack diagram (as shown in the right figure of FIG. 1). As shown in FIG. 1, on a link of a PC5 interface, an ADAPT layer is supported. In the user plane protocol stack diagram, an IP layer, an SDAP (Service Data Adaptation Protocol) layer and a PDCP (Packet Data Convergence Protocol) are located above the ADAPT layer, an RLC (Radio Link Control) layer, an MAC (Media Access Control) layer and a PHY (physical) layer are located below the ADAPT layer. In the control plane protocol stack diagram, an RRC (Radio Resource Control) layer and the PDCP layer are located above the ADAPT layer; the RLC layer, the MAC layer and the PHY layer are located below the ADAPT layer. Optionally, ADAPT in FIG. 1 may be replaced with SRAP, and the present disclosure does not impose any restrictions on this. In the user plane protocol stack diagram, the IP layer, the SDAP layer and the PDCP layer are terminated between two remote UEs, while the RLC layer, the MAC layer and the PHY layer are terminated in each PC5 link. In the control plane protocol stack diagram, the RRC layer and the PDCP layer are terminated between two remote UEs, while the RLC layer, the MAC layer and the PHY layer are terminated in each PC5 link.

Scenarios of the embodiments of the present disclosure are described through the following examples, however the present disclosure is not limited thereto.

FIG. 2 is a schematic diagram of scenarios in the embodiments of the present application. For the sake of simplicity, FIG. 2 only schematically describes a signaling interaction and data transmission mode between UE-to-UE relay UEs (U2U relay UEs), i.e., among a relay UE 203, a source UE 201 and a destination UE 202. The source UE may further be expressed as a transmission UE, and the destination UE may further be expressed as a receiving UE or a target UE. As shown in FIG. 2, the PC5 interface is adopted between the source UE 201 and the relay UE 203, as well as between the destination UE 202 and the relay UE 203. The source UE 201 to the relay UE is a first hop (1st hop), and the relay UE to the destination UE is a second hop (2nd hop). In Release 18, UE to-UE relay is being studied. The UE to-UE relay may expand coverage of sidelink transmission between two remote UEs and save power. Scenario of the present disclosure includes at least one of the following scenarios:
All UEs (source UE, relay UE, destination UE) are within network coverage;
All UEs (source UE, relay UE, destination UE) are outside the network coverage; or,
Partial coverage, wherein at least one UE (source UE, relay UE, destination UE) is within the network coverage and at least one UE (source UE, relay UE, destination UE) is outside the network coverage.

For protocol stack structures of the relay UE 203, the source UE 201 and the destination UE 202 in FIG. 2, the protocol stack in FIG. 1 may be referred to, which is not repeated here.

Inventor finds that for U2U relay of layer 2 (L2), whether to support the multiplexing of data from different destination UEs to the same RLC channel is a problem that needs to be solved. Furthermore, if the source UE supports multiplexing data of different destination UEs to the same RLC channel, it is currently unclear how the source UE multiplexes data of different destination UEs to the same RLC channel to perform transmission. For the relay UE, since the MAC layer only transmits data to the destination UE corresponding to one destination L2 ID at a time, it is also unclear how the MAC layer of the relay UE distinguishes data of different destination UEs to select the destination UE to perform data transmission, etc.

Therefore, whether to support the multiplexing of data from different destination terminal equipments (destination UEs) to the same RLC channel and how the UEs perform data transmission are problems that need to be solved.

For at least one of the above problems, the embodiments of the present disclosure provide a method and an apparatus for receiving and transmitting data, and a communication system.

### Embodiments of a First Aspect

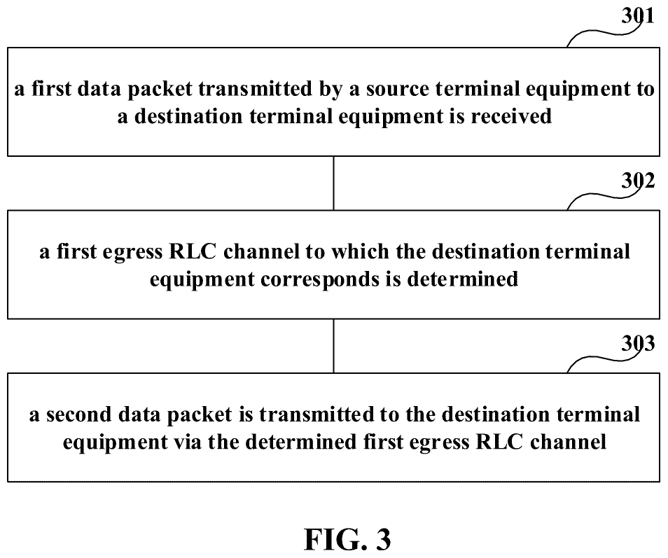

FIG. 3 is a schematic diagram of a method for receiving and transmitting data in the embodiments of the present disclosure. As shown in FIG. 3, the method is applicable to a relay terminal equipment, and the method includes:
301, a first data packet transmitted by a source terminal equipment to a destination terminal equipment is received, the first data packet including data transmitted by the source terminal equipment to the destination terminal equipment;
302, a first egress RLC channel to which the destination terminal equipment corresponds is determined, wherein first egress RLC channels to which different destination terminal equipments correspond are different; and
303, a second data packet is transmitted to the destination terminal equipment via the determined first egress RLC channel, the second data packet including the data.

According to the above embodiment, different destination terminal equipments correspond to different egress RLC channels, a relay equipment is able to determine an egress RLC channel to which the determination terminal equipment corresponds, and transmit received data to a corresponding determination terminal equipment according to a determined egress RLC channel; hence, in the case of supporting and not supporting the multiplexing of data from different destination terminal equipments to the same RLC channel, it is capable of transmitting received data to corresponding destination terminal equipments, which solves said problems existing in related arts.

It should be noted that the above FIG. 3 only schematically describes the embodiments of the present disclosure, but the present disclosure is not limited thereto. For example, an execution step of each operation may be adjusted appropriately, moreover other some operations may be increased or reduced. Persons skilled in the art may make appropriate modifications according to the above contents, not limited to the records in the above FIG. 3.

In some embodiments, the first data packet transmitted by the source terminal equipment to the destination terminal equipment and received in 301 may be transmitted by the source terminal equipment via the same second egress RLC channel. Thus, when the source terminal equipment transmits data of at least two different destination terminal equipments, the data may be multiplexed to the same egress RLC channel for transmission, and the relay terminal equipment may receive data of at least two different destination terminal equipments transmitted via the egress RLC channel. Accordingly, the problem of data transmission and reception in the case of supporting data multiplexing may be solved.

In some embodiments, the first data packet transmitted by the source terminal equipment to the destination terminal equipment and received in 301 may be transmitted by the source terminal equipment via different second egress RLC channels. Thus, when the source terminal equipment transmits data of at least two different destination terminal equipments, the data may not be multiplexed to the same egress RLC channel for transmission, but data of different destination terminal equipments are transmitted via different egress RLC channels. Accordingly, the problem of data transmission and reception in the case of not supporting data multiplexing may be solved.

In some embodiments, in 302, the determining a first egress RLC channel to which the destination terminal equipment corresponds includes: determining a first egress RLC channel with which a radio bearer (RB) of the destination terminal equipment is associated, RBs of different destination terminal equipments being associated with different first egress RLC channels. For example, a first egress RLC channel with which a radio bearer (RB) of the destination terminal equipment is associated is determined, thus in 303, a second data packet may be transmitted via the first egress RLC channel. The relay terminal equipment may determine the first egress RLC channel with which the radio bearer (RB) of the destination terminal equipment is associated according to a mapping relationship between the RB of the destination terminal equipment and an egress RLC channel (for example, obtained via first configuration information or determined by a relay equipment itself). Accordingly, in the case of supporting and not supporting the multiplexing of data from different destination terminal equipments to the same RLC channel, it is capable of transmitting received data to corresponding destination terminal equipments.

In some embodiments, the first data packet received in 301 may further include an identifier (DST ID) able to be mapped to the destination terminal equipment, and a radio bearer identifier (RB ID). In this way, in 302, the determining the first egress RLC channel with which an RB of the destination terminal equipment is associated includes: determining the first egress RLC channel with which the RB of the destination terminal equipment is associated according to the identifier able to be mapped to the destination terminal equipment, the radio bearer identifier and first configuration information. For example, a receiving entity (such as an SRAP receiving entity) of the relay equipment receives the first data packet. By parsing the data packet, the receiving entity may obtain a DST ID and an RB ID in a header of the first data packet. The receiving entity forwards the DST ID, the RB ID and data in the first data packet to a transmitting entity (such as an SRAP transmitting entity), the transmitting entity determines the first egress RLC channel according to the obtained DST ID, RB ID and the first configuration information. Or, a receiving entity (such as an SRAP receiving entity) of the relay equipment receives the first data packet, and forwards it to a transmitting entity (such as an SRAP transmitting entity). By parsing the data packet, the transmitting entity may obtain a DST ID and an RB ID in a header of the first data packet, and determines the first egress RLC channel according to the obtained DST ID, RB ID and the first configuration information.

In some embodiments, the first configuration information includes an egress RLC channel with which the RB of the destination terminal equipment is associated, or an RB of the destination terminal equipment with which an egress RLC channel is associated, but is not limited thereto. For example, the first configuration information includes an egress RLC channel with which the RB of the destination terminal equipment is associated, such as an egress RLC channel ID with which one RB ID is associated, wherein an RB of one destination terminal equipment is associated with one egress RLC channel. Or, the first configuration information includes an RB of the destination terminal equipment with which an egress RLC channel is associated, such as an RB ID with which one egress RLC channel ID is associated, wherein one egress RLC channel is associated with one destination terminal equipment. The radio bear identifier (RB ID) in the embodiments of the present disclosure e.g. may be: a Signalling Radio Bearer Identifier (SRB ID) and/or a Data Radio Bearer Identifier (DRB ID). In this way, in the case of supporting and not supporting the multiplexing of data from different destination terminal equipments to the same RLC channel, it is capable of transmitting received data of different destination terminal equipments to corresponding destination terminal equipments via different egress RLC channels.

In some embodiments, in 302, the relay terminal equipment determines the first egress RLC channel with which the RB of the destination terminal equipment is associated according to the identifier able to be mapped to the destination terminal equipment and the radio bearer identifier. For example, the relay terminal equipment determines the first egress RLC channel with which the RB of the destination terminal equipment is associated according to the identifier able to be mapped to the destination terminal equipment and the radio bearer identifier as well as implementation of a relay equipment or information stored by the relay equipment. Implementation refers to a method determined by a relay terminal itself, stored information refers to information stored in the relay terminal, such as information stored according to previous configuration information or information factory-stored by the relay terminal equipment, etc.

In some embodiments, different RBs of a pair of the source terminal equipment and the destination terminal equipment have different RB IDs, that is, an identifier of the source terminal equipment, an identifier of the destination terminal equipment and RB IDs may identify one RB; or, in the source terminal equipment, different RBs of identical or different destination terminal equipments have different RB IDs, that is, an identifier of the source terminal equipment and RB IDs may identify one RB; or, in the destination terminal equipment, different RBs of identical or different source terminal equipments have different RB IDs, that is, an identifier of the destination terminal equipment and RB IDs may identify one RB; or, RB IDs may identify one RB.

A relationship between “the identifier of the source terminal equipment” in the embodiments and “the identifier able to be mapped to the source terminal equipment” in the aforementioned other embodiments is: “the identifier able to be mapped to the source terminal equipment” includes “the identifier of the source terminal equipment”, the identifier of the source terminal equipment e.g. may be an L2 identifier of the source terminal equipment, or a local identifier of the source terminal equipment, etc. Similarly, a relationship between “the identifier of the destination terminal equipment” in the embodiments and “the identifier able to be mapped to the destination terminal equipment” in the aforementioned other embodiments is: “the identifier able to be mapped to the destination terminal equipment” includes “the identifier of the destination terminal equipment”, the identifier of the destination terminal equipment e.g. may be an L2 identifier of the destination terminal equipment, or a local identifier of the destination terminal equipment, etc.

In some embodiments, the first configuration information may be from a network device, and/or from the source terminal equipment, and/or from pre-configuration of the relay terminal equipment, the present disclosure does not define in this regard. For example, the first configuration information is transmitted by the network device to the relay terminal equipment, for example, the network device transmits it to the relay terminal equipment via system information or an RRC dedicated message; and/or the first configuration information is transmitted from the source terminal equipment to the relay terminal equipment, for example, the source terminal equipment transmits it to the relay terminal equipment via a PC5-RRC message or PC5-S signaling; and/or the first configuration information is included in pre-configured information of the relay terminal equipment, for example, it is included in pre-configuration of the relay terminal equipment. In this situation, the method may further include (not shown in the drawings): obtaining the first configuration information. The first configuration information may be obtained in the following way: the relay terminal equipment receives the first configuration information transmitted by the network device and/or the source terminal equipment; and/or the first configuration information is obtained from pre-configuration information of the relay terminal equipment.

In some embodiments, the identifier able to be mapped to the destination terminal equipment includes: a layer-2 (L2) identifier (L2 ID) of the source terminal equipment; or an L2 identifier of the destination terminal equipment; or an L2 identifier pair of the source terminal equipment and the destination terminal equipment. For example, the L2 identifier of the source terminal equipment and/or the L2 identifier of the destination terminal equipment may be determined by a V2X layer of the source terminal equipment according to an existing method, the length of the L2 identifier is 24 bits.

In some embodiments, the identifier able to be mapped to the destination terminal equipment (DST ID) may further be a local identifier (local ID) of the source terminal equipment, or a local identifier of the destination terminal equipment, or a local identifier pair of the source terminal equipment and the destination terminal equipment, or a local identifier of a pair of the source terminal equipment and the destination terminal equipment. For example, the length of the local identifier of the source terminal equipment and the length of the local identifier of the destination terminal equipment may be less than 24 bits. The local identifier pair of the source terminal equipment and the destination terminal equipment may be a pair of local identifiers of the source terminal equipment and the destination terminal equipment, such as the local ID of the source terminal equipment+the local ID of the destination terminal equipment. For example, it is assumed that the length of the local ID of the source terminal equipment and the length of the local ID of the destination terminal equipment are both 8 bits, the length of the local identifier pair is 16 bits; a local identifier of a pair of the source terminal equipment and the destination terminal equipment may be a local ID set or used for a pair of the source terminal equipment and the destination terminal equipment, the local ID identifies the pair of the source terminal equipment and the destination terminal equipment. Lengths of the aforementioned local IDs may be e.g. 4 bits, 8 bits, or 12 bits, etc. Therefore, when local identifiers are used as identifiers able to be mapped to the destination terminal equipments, overhead may be saved. For specific contents and determination methods of local IDs, related arts may be referred to, the present disclosure does not define in this regard.

In some embodiments, in 303, the second data packet is transmitted to the destination terminal equipment via the first egress RLC channel corresponding to the destination terminal equipment determined in 302, the second data packet includes not only data transmitted by the source terminal equipment to the destination terminal equipment, but also an identifier able to be mapped to the source terminal equipment (SRC ID).

In some embodiments, the identifier able to be mapped to the source terminal equipment includes: a layer-2 (L2) identifier (L2 ID) of the source terminal equipment; or an L2 identifier of the destination terminal equipment; or an L2 identifier pair of the source terminal equipment and the destination terminal equipment. For example, the L2 identifier of the source terminal equipment and/or the L2 identifier of the destination terminal equipment may be determined by a V2X layer of the terminal equipment according to an existing method, the length of the L2 identifier is 24 bits.

In some embodiments, the identifier able to be mapped to the source terminal equipment may further be a local identifier (local ID) of the source terminal equipment, or a local identifier of the destination terminal equipment, or a local identifier pair of the source terminal equipment and the destination terminal equipment, or a local identifier of a pair of the source terminal equipment and the destination terminal equipment. For example, the length of the local identifier of the source terminal equipment and the length of the local identifier of the destination terminal equipment may be less than 24 bits, which is similar to the above embodiments and is not elaborated here. Therefore, when local identifiers are used as identifiers able to be mapped to the destination terminal equipments, overhead may be saved. For specific contents and determination methods of local IDs, related arts may be referred to, the present disclosure does not define in this regard.

In the above embodiments, the RLC channel may further be expressed as an RLC bearer or an RLC entity.

As may be known from the above embodiments, in a case where the U2U relay of layer 2 (L2) supports multiplexing data of different destination terminal equipments (UEs) to the same RLC channel and does not support multiplexing the data of different destination UEs to the same RLC channel, the relay UE determines an egress RLC channel corresponding to the destination UE according to an egress RLC channel associated with a radio bearer (RB) of the destination UE, so as to transmit the data transmitted from the source UE to the destination UE to corresponding destination UEs via the determined egress RLC channel. In addition, in a case where the U2U relay of layer 2 (L2) supports multiplexing data of different destination UEs to the same RLC channel, an MAC layer of the relay UE is capable of distinguishing data (multiplexed data) of different destination UEs, so as to select data of corresponding destination UEs to perform transmission.

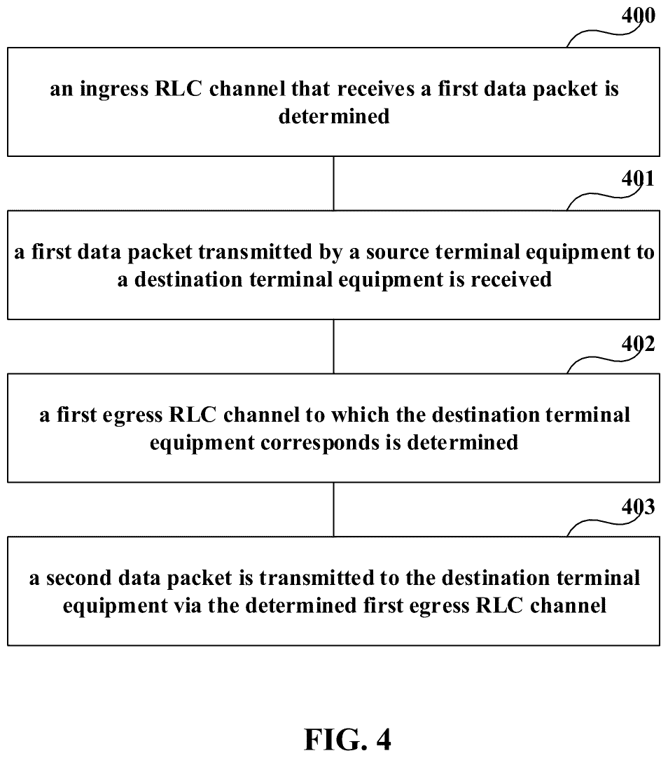

FIG. 4 is a schematic diagram of a method for receiving and transmitting data in the embodiments of the present disclosure. As shown in FIG. 4, the method is applicable to a relay terminal equipment, and the method includes steps 400, 401, 402 and 403. Contents of 401 to 403 are respectively similar to those of 301 to 303 in FIG. 3. Here, the same contents are not elaborated further, and differences are explained in detail. As shown in FIG. 4, the method includes:
400, an ingress RLC channel that receives a first data packet transmitted by a source terminal equipment to a destination terminal equipment is determined, the first data packet including data transmitted by the source terminal equipment to the destination terminal equipment.

In some embodiments, in 401, the first data packet transmitted by the source terminal equipment to the destination terminal equipment may be received via the ingress RLC channel determined in 400.

In some embodiments, in 400, determining an ingress RLC channel that receives the first data packet includes: determining an ingress RLC channel with which a logical channel of the determination terminal equipment is associated. For example, an ingress RLC channel with which a logical channel of the determination terminal equipment is associated may be determined, so that the ingress RLC channel with which the logical channel of the determination terminal equipment is associated may be used as an ingress RLC channel that receives the first data packet. In 401, the first data packet is received via the determined ingress RLC channel. The relay terminal equipment may determine the ingress RLC channel with which the logical channel of the determination terminal equipment is associated according to information on association between the logical channel of the determination terminal equipment and the ingress RLC channel (a mapping relationship, such as second configuration information). For example, the relay terminal equipment determines an associated ingress RLC channel according to the logical channel of the destination terminal equipment, a logical channel of one destination terminal equipment is associated with one ingress RLC channel. In the case of not supporting multiplexing of data of different destination terminal equipments to the same RLC channel, one ingress RLC channel is associated with the logical channel of one destination terminal equipment, and in the case of supporting multiplexing of data of different destination terminal equipments to the same RLC channel, one ingress RLC channel may be associated with logical channels of one or more destination terminal equipments.

In some embodiments, the determining an ingress RLC channel with which a logical channel of the determination terminal equipment is associated includes: determining the ingress RLC channel receiving the first data packet according to an identifier able to be mapped to the destination terminal equipment, a logical channel identifier and second configuration information. For example, the identifier able to be mapped to the destination terminal equipment is an L2 identifier of the source terminal equipment and/or an L2 identifier of the destination terminal equipment, high 16 bits of the L2 identifier of the source terminal equipment and high 8 bits of the L2 identifier of the destination terminal equipment are included in a header of a MAC PDU received by the relay terminal equipment. Low 8 bits of the L2 identifier of the source terminal equipment and low 16 bits of the L2 identifier of the destination terminal equipment are included in Sidelink control Information (SCI) transmitted by the source terminal equipment. When the first data packet arrives at the relay UE, PC5-PHY of the relay UE may determine a part of the L2 identifier able to be mapped to the destination terminal equipment, such as low 8 bits of the L2 identifier of the source terminal equipment and low 16 bits of the L2 identifier of the destination terminal equipment, a PC5-MAC entity of the relay UE parses the first data packet to obtain another part of the identifier able to be mapped to the destination terminal equipment, that is included in a data header of the first data packet, such as high 16 bits of the L2 identifier of the source terminal equipment and high 8 bits of the L2 identifier of the destination terminal equipment, and obtain a logical channel identifier.

The second configuration information includes but is not limited to: an ingress RLC channel with which a logical channel of the source terminal equipment and/or the destination terminal equipment is associated, the logical channel of one source terminal equipment and/or destination terminal equipment is associated with one ingress RLC channel, for example the second configuration information includes an RLC channel identifier (ID) associated with one logical channel identifier (ID); or a logical channel of the source terminal equipment and/or the destination terminal equipment with which an ingress RLC channel is associated, one ingress RLC channel is associated with a logical channel of one or more than one source terminal equipment and/or destination terminal equipment, for example the second configuration information includes one or more than one logical channel identifier with which one RLC channel ID is associated.

In some embodiments, different logical channels of a pair of the source terminal equipment and the destination terminal equipment have different logical channel identifiers, that is, an identifier of the source terminal equipment, an identifier of the destination terminal equipment and logical channel identifiers may identify one logical channel. or, in the source terminal equipment, different logical channels of identical or different destination terminal equipments have different logical channel identifiers, that is, an identifier of the source terminal equipment and logical channel identifiers may identify one logical channel; or, in the destination terminal equipment, different logical channels of identical or different source terminal equipments have different logical channel identifiers, that is, an identifier of the destination terminal equipment and logical channel identifiers may identify one logical channel; or, logical channel identifiers may identify one logical channel.

For distinctions between the identifier of the source terminal equipment and the identifier able to be mapped to the source terminal equipment, and distinctions between the identifier of the destination terminal equipment and the identifier able to be mapped to the destination terminal equipment, please refer to the aforementioned embodiments, they are not repeated here.

The following examples illustrate the method for determining the ingress RLC channel receiving the first data packet in 400.

For example, when the second configuration information includes the ingress RLC channel with which the logical channel of the source terminal equipment is associated, and the identifier able to be mapped to the destination terminal equipment is an L2 identifier of the source terminal equipment, in 400, the ingress RLC channel is determined according to the L2 identifier of the source terminal equipment, the logical channel identifier and the second configuration information. Specifically, the MAC entity of the relay terminal equipment determines the logical channel of the source terminal equipment according to the L2 identifier of the source terminal equipment and the logical channel identifier; then obtains the ingress RLC channel receiving the first data packet according to the logical channel of the source terminal equipment and the information on association between the logical channel of the source terminal equipment and the ingress RLC channel in the second configuration information.

For example, when the second configuration information includes the ingress RLC channel with which the logical channel of the source terminal equipment is associated, and the identifier able to be mapped to the destination terminal equipment is an L2 identifier of the destination terminal equipment, in 400, the ingress RLC channel is determined according to the L2 identifier of the destination terminal equipment, the logical channel identifier and the second configuration information. Specifically, the MAC entity of the relay terminal equipment determines the logical channel of the source terminal equipment according to the L2 identifier of the destination terminal equipment and the logical channel identifier; then obtains the ingress RLC channel receiving the first data packet according to the logical channel of the source terminal equipment and the information on association between the logical channel of the source terminal equipment and the ingress RLC channel in the second configuration information.

For example, when the second configuration information includes the ingress RLC channel with which the logical channel of the destination terminal equipment is associated, and the identifier able to be mapped to the destination terminal equipment is an L2 identifier of the source terminal equipment, in 400, the ingress RLC channel is determined according to the L2 identifier of the source terminal equipment, the logical channel identifier and the second configuration information. Specifically, the MAC entity of the relay terminal equipment determines the logical channel of the destination terminal equipment according to the L2 identifier of the source terminal equipment and the logical channel identifier; then obtains the ingress RLC channel receiving the first data packet according to the logical channel of the destination terminal equipment and the information on association between the logical channel of the destination terminal equipment and the ingress RLC channel in the second configuration information.

For example, when the second configuration information includes the ingress RLC channel with which the logical channel of the destination terminal equipment is associated, and the identifier able to be mapped to the destination terminal equipment is an L2 identifier of the destination terminal equipment, in 400, the ingress RLC channel is determined according to the L2 identifier of the destination terminal equipment, the logical channel identifier and the second configuration information. Specifically, the MAC entity of the relay terminal equipment determines the logical channel of the destination terminal equipment according to the L2 identifier of the destination terminal equipment and the logical channel identifier; then obtains the ingress RLC channel receiving the first data packet according to the logical channel of the destination terminal equipment and the information on association between the logical channel of the destination terminal equipment and the ingress RLC channel in the second configuration information.

The above examples respectively illustrate a method for determining an ingress RLC channel when the second configuration information includes an ingress RLC channel with which a logical channel of the source terminal equipment and/or the destination terminal equipment is associated, and the identifier able to be mapped to the destination terminal equipment is an L2 identifier of the source terminal equipment or an L2 identifier of the destination terminal equipment. When the second configuration information includes ingress RLC channels with which logical channels of the source terminal equipment and the destination terminal equipment are associated, and the identifier able to be mapped to the destination terminal equipment (DST ID) is an L2 identifier of a pair of the source terminal equipment and the destination terminal equipment, in 400, the ingress RLC channel is determined according to the L2 identifier of the pair of the source terminal equipment and the destination terminal equipment, the logical channel identifier and the second configuration information. Specifically, the MAC entity of the relay terminal equipment determines the logical channels of the source terminal equipment and the destination terminal equipment according to the L2 identifier of the pair of the source terminal equipment and the destination terminal equipment and the logical channel identifier; then obtains the ingress RLC channel receiving the first data packet according to the logical channels of the source terminal equipment and the destination terminal equipment and the information on association between the logical channels of the source terminal equipment and the destination terminal equipment and the ingress RLC channel in the second configuration information.

The second configuration information may be from a network device, and/or from the source terminal equipment, and/or from pre-configuration of the relay terminal equipment, the present disclosure does not define in this regard. For example, the second configuration information is transmitted by the network device to the relay terminal equipment; and/or the second configuration information is transmitted from the source terminal equipment to the relay terminal equipment; and/or the second configuration information is included in pre-configured information of the relay terminal equipment. In this situation, the method may further include (not shown in the drawings): obtaining the second configuration information. The second configuration information may be obtained in the following way: the relay terminal equipment receives the second configuration information transmitted by the network device and/or the source terminal equipment; and/or the second configuration information is obtained from pre-configuration information of the relay terminal equipment.

In this embodiment, the identifier able to be mapped to the destination terminal equipment is as described above and is not elaborated here.

For this embodiment, in 400, determining the ingress RLC channel receiving the first data packet may be implemented by an MAC layer of the relay UE. For example, when the first data packet arrives at the relay UE, PC5-PHY of the relay UE may determine a part of the identifier able to be mapped to the destination terminal equipment, such as low 8 bits of the L2 ID of the source terminal equipment and low 16 bits of the destination terminal equipment, a PC5-MAC entity of the relay UE parses the first data packet to obtain another part of the identifier able to be mapped to the destination terminal equipment, that is included in a data header of the first data packet, such as high 16 bits of the L2 identifier of the source terminal equipment and high 8 bits of the L2 ID of the destination terminal equipment, and obtain a logical channel identifier. The second configuration information is configured with the ingress RLC channel with which the logical channel of the destination terminal equipment is associated. Therefore, the PC5-MAC entity of the relay UE determines the ingress RLC channel receiving the first data packet based on the identifier able to be mapped to the destination terminal equipment, the logical channel identifier and the second configuration information.

In some embodiments, the determining an ingress RLC channel with which a logical channel of the determination terminal equipment is associated includes: determining the ingress RLC channel receiving the first data packet according to an identifier able to be mapped to the destination terminal equipment and a logical channel identifier.

The relay UE itself determines an ingress RLC channel with which a logical channel of the destination terminal equipment is associated. For example, when the first data packet of the logical channel from a source terminal equipment to a destination terminal equipment reaches the PC5-MAC entity of the relay terminal equipment, the PC5-MAC entity may determine that one ingress RLC channel is associated with the logical channel of the source terminal equipment and/or the destination terminal equipment. The relay UE receives data transmitted by the source terminal equipment to the destination terminal equipment via the determined ingress RLC channel with which the logical channel of the source terminal equipment and/or the destination terminal equipment is associated.

In this embodiment, the identifier able to be mapped to the destination terminal equipment is as described above and is not elaborated here.

For this embodiment, in 400, determining the ingress RLC channel receiving the first data packet may be implemented by an MAC layer of the relay UE. For example, when the first data packet arrives at the relay UE, PC5-PHY of the relay UE may determine a part of the identifier able to be mapped to the destination terminal equipment, such as low 8 bits of the L2 ID of the source terminal equipment and low 16 bits of the L2 identifier of the destination terminal equipment, a PC5-MAC entity of the relay UE parses the first data packet to obtain another part of the identifier able to be mapped to the destination terminal equipment, that is included in a data header of the first data packet, such as high 16 bits of the L2 identifier of the source terminal equipment and high 8 bits of the L2 ID of the destination terminal equipment, and obtain a logical channel identifier. The PC5-MAC entity of the relay UE determines by itself that one ingress RLC channel is associated with a logical channel of the destination terminal equipment, and receives the first data packet via the determined ingress RLC channel. The PC5-MAC entity of the relay UE determines by itself an ingress RLC channel, such as an idle ingress RLC channel.

In some embodiments, the RLC channel may be expressed as an RLC bearer or an RLC entity. For the scenario shown in FIG. 2, the RLC channel may be a PC5-RLC channel, or a PC5-RLC bearer, or a PC5-RLC entity.

In some embodiments, the egress RLC channel may be expressed as an egress RLC bearer or an egress RLC entity. For the scenario shown in FIG. 2, the egress RLC channel may be an egress PC5-RLC channel, or an egress PC5-RLC bearer, or an egress PC5-RLC entity.

In some embodiments, the ingress RLC channel may be expressed as an ingress RLC bearer or an ingress RLC entity. For the scenario shown in FIG. 2, the ingress RLC channel may be an ingress PC5-RLC channel, or an ingress PC5-RLC bearer, or an ingress PC5-RLC entity.

As may be known from the above embodiments, the relay terminal equipment (the relay UE) in the embodiments of the present disclosure determines an egress RLC channel corresponding to the destination UE according to an egress RLC channel associated with a radio bearer (RB) of the destination UE, so as to transmit the data transmitted from the source UE to the destination UE to corresponding destination UEs via the determined egress RLC channel. In a case where the U2U relay of layer 2 (L2) supports or does not support multiplexing data of different destination terminal equipments (UEs) to the same RLC channel, an MAC layer of the relay UE is capable of distinguishing data (multiplexed data) of different destination UEs, so as to select data of corresponding destination UEs to perform transmission. In the case of supporting multiplexing of data of different destination terminal equipments (UEs) to the same RLC channel, the number of RLC channels may be saved, capability requirements for terminal equipments may be reduced, and the processing complexity of terminal equipments may be reduced.

### Embodiments of a Second Aspect

Embodiments of the present disclosure provide a method for transmitting data.

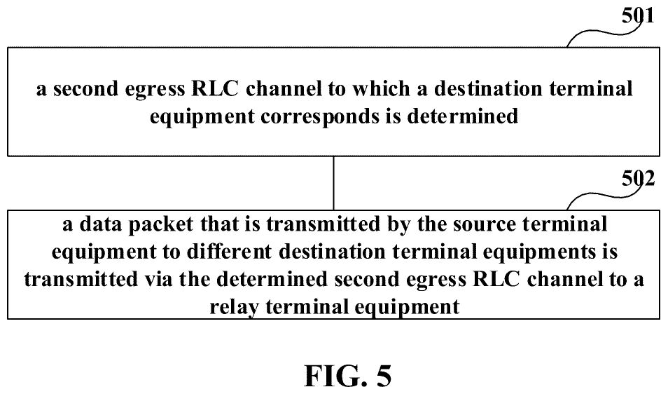

FIG. 5 is a schematic diagram of a data transmitting method in the embodiments of the present disclosure. The method is applicable to a source terminal equipment, and is aimed at situations that support data multiplexing. As shown in FIG. 5, the method includes:
501, a second egress RLC channel to which a destination terminal equipment corresponds is determined, wherein different destination terminal equipments correspond to the same second egress RLC channel; and
502, a data packet that is transmitted by the source terminal equipment to different destination terminal equipments is transmitted via the determined second egress RLC channel to a relay terminal equipment, the data packet including data transmitted by the source terminal equipment to the destination terminal equipment.

According to the above embodiment, in the case of supporting multiplexing of data of different destination terminal equipments to the same RLC channel, the source terminal equipment may transmit a data packet to different destination terminal equipments, such as at least two destination terminal equipments, via the same egress RLC channel, which may save the number of RLC channels, reduce capability requirements for a UE and decrease the processing complexity of the UE.

It should be noted that the above FIG. 5 only schematically describes the embodiments of the present disclosure, but the present disclosure is not limited thereto. For example, an execution step of each operation may be adjusted appropriately, moreover other some operations may be increased or reduced. Persons skilled in the art may make appropriate modifications according to the above contents, not limited to the records in the above FIG. 5.

In some embodiments, in 501, the determining a second egress RLC channel to which the destination terminal equipment corresponds includes: determining a second egress RLC channel with which an RB of the destination terminal equipment is associated, wherein RBs of different destination terminal equipments (such as at least two destination terminal equipments) are associated with the same second egress RLC channel. Accordingly, when the source terminal equipment transmits data to different destination terminal equipments (at least two destination terminal equipments) via the same egress RLC channel, the second egress RLC channel may be determined according to the second egress RLC channel associated with the RBs of the destination terminal equipments.

In some embodiments, different RBs of a pair of the source terminal equipment and the destination terminal equipment have different RB IDs, i.e., an identifier of the source terminal equipment, an identifier of the destination terminal equipment and RB IDs may identify one RB; or, in the source terminal equipment, different RBs of identical or different destination terminal equipments have different RB IDs, i.e., an identifier of the source terminal equipment and RB IDs may identify one RB; or, in the destination terminal equipment, different RBs of identical or different source terminal equipments have different RB IDs, i.e., an identifier of the destination terminal equipment and RB IDs may identify one RB; or RB IDs may identify one RB.

In some embodiments, the second egress RLC channel may be determined based on a mapping relationship (such as the second configuration information) between the RB of the destination terminal equipment and the egress RLC channel. For example, the second egress RLC channel with which the RB of the destination terminal equipment is associated may be determined according to the identifier able to be mapped to destination terminal equipment, a radio bearer identifier and the third configuration information, wherein the third configuration information may include the second egress RLC channel with which the RB of the destination terminal equipment is associated, or the RB of the destination terminal equipment with which the second egress RLC channel is associated.

In some embodiments, the third configuration information may be from a network device, and/or from a relay terminal equipment, and/or from pre-configuration of the source terminal equipment. For example, the third configuration information is transmitted by the network device to the source terminal equipment; and/or the third configuration information is transmitted from the relay terminal equipment to the source terminal equipment; and/or the third configuration information is included in pre-configuration of the source terminal equipment. In this situation, the method may further include (not shown in the drawings): obtaining the third configuration information. The third configuration information may be obtained in the following way: the source terminal equipment receives the third configuration information transmitted by the network device and/or the relay terminal equipment; and/or the third configuration information is obtained from pre-configuration information of the source terminal equipment.

In some embodiments, after the source terminal equipment determines the identifier able to be mapped to the destination terminal equipment and the radio bearer identifier, the method may further include: placing the identifier able to be mapped to the destination terminal equipment and the radio bearer identifier into a data packet transmitted to the destination terminal equipment, such as in a header of a SRAP PDU, in this way, in the step 502, the data packet transmitted by the source terminal equipment to the terminal equipment may further include the identifier able to be mapped to the destination terminal equipment and the radio bearer identifier. Accordingly, when the relay terminal equipment receives a data packet including the identifier able to be mapped to the destination terminal equipment and the radio bearer identifier, the first egress RLC channel with which the RB of the destination terminal equipment is associated may be determined according to the identifier able to be mapped to the destination terminal equipment, the radio bearer identifier and the obtained first configuration information.

In some embodiments, the identifier able to be mapped to the destination terminal equipment is the same as that described in the above embodiments. Its content is combined here and is not elaborated this time.

In this embodiment, the RLC channel may be expressed as an RLC bearer or an RLC entity. For the scenario shown in FIG. 2, the RLC channel may be a PC5-RLC channel, or a PC5-RLC bearer, or a PC5-RLC entity.

In this embodiment, the egress RLC channel may be expressed as an egress RLC bearer or an egress RLC entity. For the scenario shown in FIG. 2, the egress RLC channel may be an egress PC5-RLC channel, or an egress PC5-RLC bearer, or an egress PC5-RLC entity.

In this embodiment, the ingress RLC channel may be expressed as an ingress RLC bearer or an ingress RLC entity. For the scenario shown in FIG. 2, the ingress RLC channel may be an ingress PC5-RLC channel, or an ingress PC5-RLC bearer, or an ingress PC5-RLC entity.

Each of the above embodiments is only illustrative for the embodiments of the present disclosure, but the present disclosure is not limited to this, appropriate modifications may be further made based on the above each embodiment. For example, each of the above embodiments may be used individually, or one or more of the above embodiments may be combined.

It's worth noting that the above text only describes steps related to the present disclosure, but the present disclosure is not limited thereto. The method for transmitting data in the present disclosure may further include other steps. For specific contents of these steps, relevant technologies may be referred to.

### Embodiments of a Third Aspect

Embodiments of the present disclosure provide a method for transmitting data.

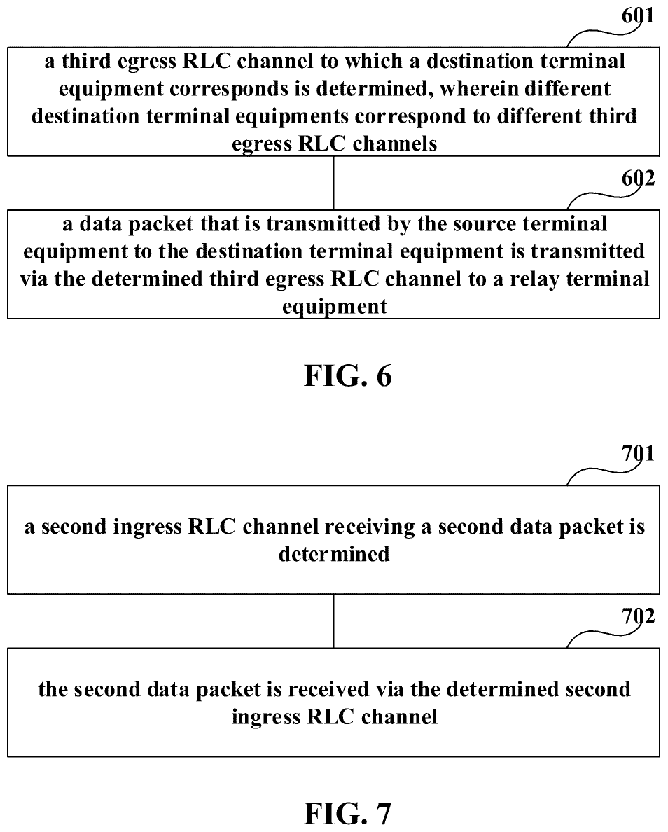

FIG. 6 is a schematic diagram of a data transmitting method in the embodiments of the present disclosure. The method is applicable to a source terminal equipment, and is aimed at situations that do not support data multiplexing. As shown in FIG. 6, the method includes:
601, a third egress RLC channel to which a destination terminal equipment corresponds is determined, wherein different destination terminal equipments correspond to different third egress RLC channels; and
602, a data packet that is transmitted by the source terminal equipment to the destination terminal equipment is transmitted via the determined third egress RLC channel to a relay terminal equipment,
wherein the data packet includes data transmitted by the source terminal equipment to the destination terminal equipment and a radio bearer identifier, but does not include an identifier able to be mapped to the destination terminal equipment.

According to the above embodiment, the source terminal equipments respectively transmit a data packet to different destination terminal equipments via different egress RLC channels, and do not supported multiplexing data of different destination terminal equipments to the same RLC channel. In a first hop, in a data packet transmitted from the source terminal equipment to the destination terminal equipment, the identifier able to be mapped to the destination terminal equipment may be default or not reflected to save overhead.

That is to say, the data packet may include data transmitted by the source terminal equipment to the destination terminal equipment, the identifier able to be mapped to the destination terminal equipment and a radio bearer identifier, but the identifier able to be mapped to the destination terminal equipment may also be default or not reflected.

It should be noted that the above FIG. 6 only schematically describes the embodiments of the present disclosure, but the present disclosure is not limited thereto. For example, an execution step of each operation may be adjusted appropriately, moreover other some operations may be increased or reduced. Persons skilled in the art may make appropriate modifications according to the above contents, not limited to the records in the above FIG. 6.

In this way, when the identifier able to be mapped to the destination terminal equipment is default, the method may further include: placing the radio bearer identifier (not including the identifier mapped to the destination terminal equipment) into a data header of a data packet transmitted to the destination terminal equipment, in this way, in the step 602, the data packet transmitted by the source terminal equipment to the terminal equipment includes the radio bearer identifier but does not include the identifier mapped to the destination terminal equipment. Therefore, when the identifier mapped to the destination terminal equipment is default, overhead may be saved.

In some embodiments, in 601, the determining a third egress RLC channel to which the destination terminal equipment corresponds includes: determining a third egress RLC channel with which an RB of the destination terminal equipment is associated, RBs of different destination terminal equipments being associated with different third egress RLC channels. Accordingly, when the source terminal equipment transmits data to different destination terminal equipments via different egress RLC channels, the third egress RLC channel may be determined according to the third egress RLC channel associated with the RBs of the destination terminal equipments.

In one embodiment, the third egress RLC channel may be determined based on a mapping relationship (such as the second configuration information) between the RB of the destination terminal equipment and the egress RLC channel. For example, the third egress RLC channel with which the RB of the destination terminal equipment is associated may be determined according to the identifier able to be mapped to destination terminal equipment, a radio bearer identifier and fourth configuration information, wherein the fourth configuration information may include the third egress RLC channel with which the RB of the destination terminal equipment is associated, or the RB of the destination terminal equipment with which the third egress RLC channel is associated.

In some embodiments, the fourth configuration information may be from a network device, and/or from a relay terminal equipment, and/or from pre-configuration of the source terminal equipment. For example, the fourth configuration information is transmitted by the network device to the source terminal equipment; and/or the fourth configuration information is transmitted from the relay terminal equipment to the source terminal equipment; and/or the fourth configuration information is included in pre-configuration of the source terminal equipment. In this situation, the method may further include (not shown in the drawings): obtaining the fourth configuration information. The fourth configuration information may be obtained in the following way: the source terminal equipment receives the fourth configuration information transmitted by the network device and/or the relay terminal equipment; and/or the fourth configuration information is obtained from pre-configuration information of the source terminal equipment.

Accordingly, when the relay terminal equipment receives a data packet including the identifier able to be mapped to the destination terminal equipment, the radio bearer identifier and the logical channel identifier, the ingress RLC channel with which the logical channel of the destination terminal equipment is associated may be determined according to the identifier mapped to the destination terminal equipment, the radio bearer identifier and the obtained second configuration information; the first egress RLC channel with which the RB of the destination terminal equipment is associated may be determined according to the identifier mapped to the destination terminal equipment, the radio bearer identifier and the obtained first configuration information.

In some embodiments, the identifier able to be mapped to the destination terminal equipment is the same as that described in the above embodiments. Its content is combined here and is not elaborated this time.

In this embodiment, the RLC channel may be expressed as an RLC bearer or an RLC entity. For the scenario shown in FIG. 2, the RLC channel may be a PC5-RLC channel, or a PC5-RLC bearer, or a PC5-RLC entity.

In this embodiment, the egress RLC channel may be expressed as an egress RLC bearer or an egress RLC entity. For the scenario shown in FIG. 2, the egress RLC channel may be an egress PC5-RLC channel, or an egress PC5-RLC bearer, or an egress PC5-RLC entity.

Each of the above embodiments is only illustrative for the embodiments of the present disclosure, but the present disclosure is not limited to this, appropriate modifications may be further made based on the above each embodiment. For example, each of the above embodiments may be used individually, or one or more of the above embodiments may be combined.

It's worth noting that the above text only describes steps related to the present disclosure, but the present disclosure is not limited thereto. The method for transmitting data in the present disclosure may further include other steps. For specific contents of these steps, relevant technologies may be referred to.

### Embodiments of a Fourth Aspect

Embodiments of the present disclosure provide a method for receiving data.

FIG. 7 is a schematic diagram of a method for receiving data in the embodiments of the present disclosure, applicable to a destination terminal equipment. As shown in FIG. 7, the method includes:
701, a second ingress RLC channel receiving a second data packet is determined, the second data packet including data transmitted from a source terminal equipment to a destination terminal equipment; and
702, the second data packet is received via the determined second ingress RLC channel.

According to the above embodiment, the destination terminal equipment may receive a data packet transmitted by the source terminal equipment via the determined ingress RLC channel, which is applicable to situations of supporting and not supporting multiplexing data of different destination terminal equipments to the same RLC channel.

In some embodiments, in 701, determining an ingress RLC channel receiving the second data packet includes: determining an ingress RLC channel with which an RB of the source terminal equipment is associated. For example, an ingress RLC channel with which an RB of the source terminal equipment is associated may be determined.

In some embodiments, an ingress RLC channel with which an RB of the source terminal equipment is associated may be determined according to an identifier able to be mapped to the source terminal equipment, a radio bearer identifier and fifth configuration information.

In some embodiments, the second data packet may further include an identifier able to be mapped to the source terminal equipment, and a radio bearer identifier. For example, the PC5-PHY of a destination UE may determine a part of the identifier able to be mapped to the source terminal equipment via Sidelink control Information (SCI), such as low 8 bits of an L2 ID of the source terminal equipment and low 16 bits of an L2 ID of the destination terminal equipment. A PC5-MAC entity of a destination UE parses the second data packet to obtain another part of the identifier able to be mapped to the source terminal equipment, that is included in a data header of the second data packet, such as high 16 bits of the L2 identifier of the source terminal equipment and high 8 bits of the L2 ID of the destination terminal equipment, and obtain a radio bearer identifier. The PC5-MAC entity of the destination UE determines the ingress RLC channel with which the RB of the source terminal equipment is associated according to the identifier able to be mapped to the source terminal equipment, the radio bearer identifier and the fifth configuration information.

In some embodiments, the fifth configuration information includes an ingress RLC channel with which an RB of the source terminal equipment is associated, or an RB of the source terminal equipment with which an ingress RLC channel is associated.

In some embodiments, the fifth configuration information is from a network device, and/or from a relay terminal equipment, and/or from pre-configuration of the destination terminal equipment. For example, the fifth configuration information is transmitted by the network device to the destination terminal equipment; and/or the fifth configuration information is transmitted from the relay terminal equipment to the destination terminal equipment; and/or the fifth configuration information is included in pre-configuration of the destination terminal equipment. In this situation, the method may further include (not shown in the drawings): obtaining the fifth configuration information. The fifth configuration information may be obtained in the following way: the destination terminal equipment receives the fifth configuration information transmitted by the network device and/or the relay terminal equipment; and/or the fifth configuration information is obtained from pre-configuration information of the destination terminal equipment.

In some embodiments, a method for determining the identifier able to be mapped to the source terminal equipment and the radio bearer identifier, as well as the identifier able to be mapped to the source terminal equipment are as described in the above embodiments. Their contents are combined here and are not elaborated here.

In this embodiment, the ingress RLC channel may be expressed as an ingress RLC bearer or an ingress RLC entity. For the scenario shown in FIG. 2, the ingress RLC channel may be an ingress PC5-RLC channel, or an ingress PC5-RLC bearer, or an ingress PC5-RLC entity.

Each of the above embodiments is only illustrative for the embodiments of the present disclosure, but the present disclosure is not limited to this, appropriate modifications may be further made based on the above each embodiment. For example, each of the above embodiments may be used individually, or one or more of the above embodiments may be combined.

It's worth noting that the above text only describes steps related to the present disclosure, but the present disclosure is not limited thereto. The method for receiving data in the present disclosure may further include other steps. For specific contents of these steps, relevant technologies may be referred to.

Each of the above embodiments is only illustrative for the embodiments of the present disclosure, but the present disclosure is not limited to this, appropriate modifications may be further made based on the above each embodiment. For example, each of the above embodiments may be used individually, or one or more of the above embodiments may be combined.

### Embodiments of a Fifth Aspect

The embodiments provide a method for receiving and transmitting data, by combining with the scenario shown in FIG. 2, it is described by taking a situation that supports data multiplexing as an example. In the embodiments, the description is made by taking multiplexing of data of two different destination terminal equipments as an example, however the embodiments are not limited thereto. For transmission and reception of data of more than two destination terminal equipments, a similar method may be adopted, which is not elaborated here.

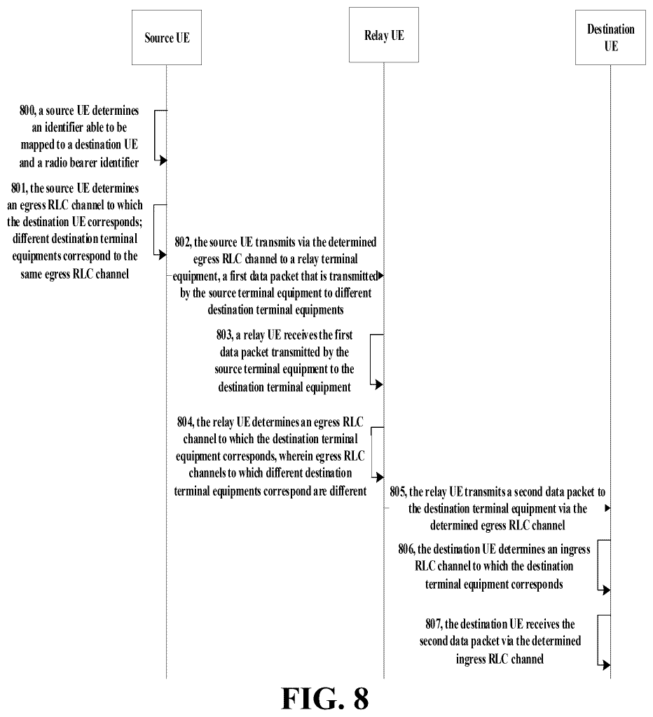

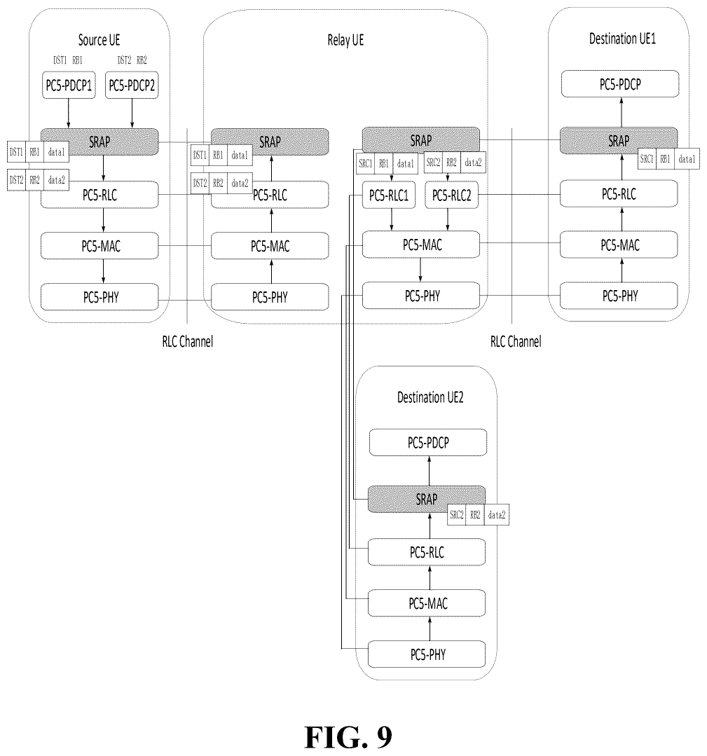

FIG. 8 is a schematic diagram of a method for receiving and transmitting data in the embodiments of the present disclosure. FIG. 9 is a schematic diagram of a system protocol stack architecture in the embodiments of the present disclosure. As shown in FIG. 8 and FIG. 9, the method includes:
800, a source UE determines an identifier able to be mapped to a destination UE and a radio bearer identifier;
801, the source UE determines an egress RLC channel to which the destination UE corresponds, wherein different destination terminal equipments correspond to the same egress RLC channel; and
wherein when the source UE transmits data to at least two destination UEs, an egress RLC channel to which the destination UE corresponds is determined, in the embodiments, the egress RLC channel may be an egress PC5-RLC channel, the source UE transmits data of more than two destination UEs via one egress PC5-RLC channel.

For example, the source UE may determine an egress RLC channel to which the destination UE corresponds (such as an egress PC5-RLC channel) according to the identifier able to be mapped to the destination UE, the radio bearer identifier and third configuration information. For example, description is made by taking destination UE1 and destination UE2 as an example, as shown in FIG. 9, the source UE determines that the egress RLC channel is a PC5-RLC via an identifier (DST1) able to be mapped to the destination UE1 and a radio bearer identifier (RB 1). The source UE determines that the egress RLC channel is a PC5-RLC via an identifier (DST2) able to be mapped to the destination UE2 and a radio bearer identifier (RB 2), i.e., the destination UE1 and the destination UE2 are mapped to the same egress RLC channel (such as PC5-RLC).

The identifier able to be mapped to the destination terminal equipment and the radio bearer identifier may be generated in 800, acquisition of the third configuration information is the same as that described in the above embodiments. Their contents are combined here and are not elaborated this time.

As shown in FIG. 9, the source UE transmits data to the destination UE1 and the destination UE2, wherein RB1 of the destination UE1 corresponds to a PC5-PDCP entity PC5-PDCP1 of the source UE, and RB2 of the destination UE2 corresponds to a PC5-PDCP entity PC5-PDCP2 of the source UE, an SRAP layer of the source UE determines that PC5-PDCP1 and PC5-PDCP2 correspond to the same egress RLC channel. Therefore, a data packet of RB1 of the destination UE1 and a data packet of RB2 of the destination UE2 are transmitted to the same egress RLC channel.

802, the source UE transmits via the determined egress RLC channel to a relay terminal equipment, a first data packet that is transmitted by the source terminal equipment to different destination terminal equipments, the first data packet including data transmitted by the source terminal equipment to the destination terminal equipment,
wherein the first data packet may include data transmitted by the source terminal equipment to the destination terminal equipment, the identifier able to be mapped to the destination terminal equipment, and the radio bearer identifier, for example the description is made by taking the destination UE1 and the destination UE2 as an example, as shown in FIG. 9, corresponding to the destination UE1, the first data packet includes data1, and may further include DST1 and RB 1; corresponding to the destination UE2, the first data packet includes data2, and may further include DST2 and RB 2.

803, a relay UE receives the first data packet transmitted by the source terminal equipment to the destination terminal equipment.

PC5-PHY of the relay UE receives Sidelink control Information (SCI) transmitted by the source UE, a PC5-MAC layer of the relay UE receives an MAC PDU transmitted by the source UE and parses the MAC PDU to obtain an identifier able to be mapped to a destination terminal equipment corresponding to the first data packet, and a logical channel identifier.

The PC5-MAC layer of the relay terminal equipment determines an ingress RLC channel with which the logical channel of the destination terminal equipment is associated according to the identifier able to be mapped to the destination terminal equipment included in the MAC PDU, the logical channel identifier, and second configuration information.

The ingress RLC channel of the relay equipment transmits the first data packet of the destination terminal equipment to an SRAP receiving entity.

804, the relay UE determines an egress RLC channel to which the destination terminal equipment corresponds, wherein egress RLC channels to which different destination terminal equipments correspond are different,
wherein the relay terminal equipment determines the egress RLC channel with which the RB of the destination terminal equipment is associated according to the identifier able to be mapped to the destination terminal equipment, the radio bearer identifier and first configuration information.

For example, as shown in FIG. 9, the SRAP transmitting entity of the relay UE determines an egress RLC channel (PC5-RLC1) with which an RB of the destination UE1 is associated according to the identifier (DST1) able to be mapped to the destination UE1, the radio bearer identifier (RB1), and the first configuration information. The SRAP transmitting entity of the relay UE determines an egress RLC channel (PC5-RLC2) with which an RB of the destination UE2 is associated according to the identifier (DST2) able to be mapped to the destination UE2, the radio bearer identifier (RB2), and the first configuration information.

805, the relay UE transmits a second data packet to the destination terminal equipment via the determined egress RLC channel, the second data packet including data transmitted by the source terminal equipment to the destination terminal equipment.

In this embodiment, before 805, the method may further include (not shown in the figure): generating a second data packet transmitted to different destination terminal equipments.

For example, as shown in FIG. 9, the relay terminal equipment receives from the source terminal equipment the first data packet transmitted by the source terminal equipment to the destination UE1, a data header of the first data packet includes an identifier (DST1) able to be mapped to the destination terminal equipment 1. The relay terminal equipment changes the identifier (DST1) able to be mapped to the destination terminal equipment 1 included in the data header of the first data packet as an identifier (SRC1) able to be mapped to the source terminal equipment. The relay terminal equipment receives from the source terminal equipment the first data packet transmitted by the source terminal equipment to the destination UE2, a data header of the first data packet includes an identifier (DST2) able to be mapped to the destination UE2. The relay terminal equipment changes the identifier (DST2) able to be mapped to the destination UE2 included in the data header of the first data packet as an identifier (SRC2) able to be mapped to the source terminal equipment. Accordingly, the second data packet may be generated. In addition, the second data packet not only includes data transmitted by the source terminal equipment to the destination terminal equipment, but also may include an identifier able to be mapped to the source terminal equipment, and a radio bearer identifier.

When source terminal equipments that transmit the first data packet to the destination terminal equipment 1 and the destination terminal equipment 2 are identical, the identifier (SRC1) able to be mapped to the source terminal equipment and the identifier (SRC2) able to be mapped to the source terminal equipment are identical. When source terminal equipments that transmit the first data packet to the destination terminal equipment 1 and the destination terminal equipment 2 are different, the identifier (SRC1) able to be mapped to the source terminal equipment and the identifier (SRC2) able to be mapped to the source terminal equipment are different.

806, the destination UE determines an ingress RLC channel to which the destination terminal equipment corresponds,
wherein the destination UE determines the egress RLC channel with which the RB of the destination terminal equipment is associated according to the identifier able to be mapped to the source terminal equipment, the radio bearer identifier, and fifth configuration information.

For example, as shown in FIG. 9, operations of receiving data by MAC layers of the destination UE1 and the destination UE2 are similar to operations of receiving data by the MAC layer of the relay UE.

807, the destination UE receives the second data packet via the determined ingress RLC channel.

As may be known from the above embodiment, in the UE to UE relay, it is possible to support multiplexing of data of different destination terminal equipments to the same RLC channel, and in the case of supporting multiplexing, the source UE may transmit data to at least two different destination UEs via the same egress RLC channel. The relay UE may receive data transmitted by the source UE to different destination UEs via the same ingress channel, and transmit data transmitted by the source UE to different destination UEs via different egress RLC channels. In the case of supporting multiplexing, the present disclosure may save the number of RLC channels, reduce capability requirements for terminal equipments, and reduce the processing complexity of terminal equipments. The relay terminal equipment may distinguish data transmitted by the source UE to different destination UEs and transmit the same via different egress RLC channels.

In this embodiment, implementation and nouns explanation of steps 800 to 802 are similar to the contents of the embodiments in the second aspect of the present disclosure. The above-mentioned relevant contents are combined here and are not repeated here.

Implementation and nouns explanation of steps 803 to 805 are similar to the contents of the embodiments in the first aspect of the present disclosure. The above-mentioned relevant contents are combined here and are not repeated here.

Implementation and nouns explanation of steps 806 to 807 are similar to the contents of the embodiments in the fourth aspect of the present disclosure. The above-mentioned relevant contents are combined here and are not repeated here.

### Embodiments of a Sixth Aspect

The embodiments provide a method for receiving and transmitting data, by combining with the scenario shown in FIG. 2, it is described by taking a situation that does not support data multiplexing as an example. In the embodiments, the description is made by taking data non-multiplexing of two different destination terminal equipments as an example, however the embodiments are not limited thereto. For transmission and reception of data of more than two destination terminal equipments, a similar method may be adopted, which is not elaborated here.

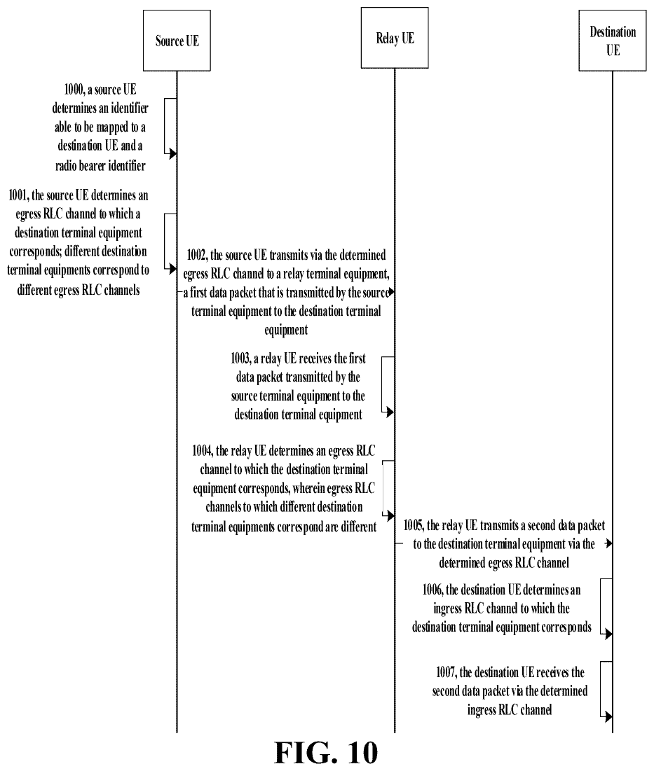

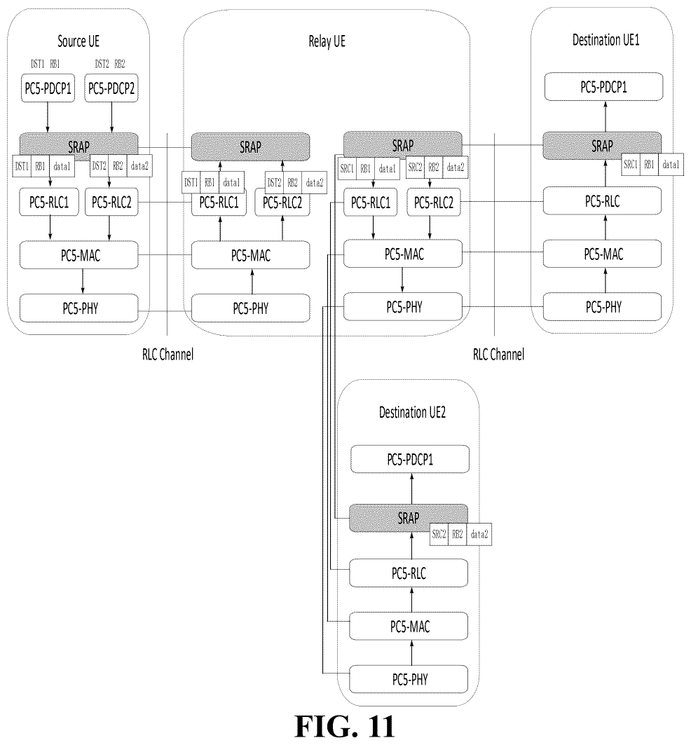

FIG. 10 is a schematic diagram of a method for receiving and transmitting data in the embodiments of the present disclosure. FIG. 11 is a schematic diagram of a system protocol stack architecture in the embodiments of the present disclosure. As shown in FIG. 10 and FIG. 11, the method includes:
1000, a source UE determines an identifier able to be mapped to a destination UE and a radio bearer identifier;
1001, the source UE determines an egress RLC channel to which a destination terminal equipment corresponds, wherein different destination terminal equipments correspond to different egress RLC channels,
wherein when the source UE transmits data to at least two destination UEs, an egress RLC channel to which the destination UE corresponds is determined, in the embodiments, the egress RLC channel may be an egress PC5-RLC channel, the source UE transmits data of one destination UE via one egress PC5-RLC channel.

For example, the source UE may determine an egress RLC channel to which the destination UE corresponds (such as an egress PC5-RLC channel) according to the identifier able to be mapped to the destination UE, the radio bearer identifier and fourth configuration information. For example, description is made by taking destination UE1 and destination UE2 as an example, as shown in FIG. 11, the source UE determines that the egress RLC channel is PC5-RLC1 via an identifier (DST1) able to be mapped to the destination UE1 and a radio bearer identifier (RB 1); the source UE determines that the egress RLC channel is PC5-RLC2 via an identifier (DST2) able to be mapped to the destination UE2 and a radio bearer identifier (RB 2), i.e., the destination UE1 and the destination UE2 are mapped to different egress RLC channels.

The identifier able to be mapped to the destination terminal equipment and the radio bearer identifier may be generated in 800, acquisition of the third configuration information is the same as that described in the above embodiments. Their contents are combined here and are not elaborated this time.

As shown in FIG. 11, the source UE transmits data to the destination UE1 and the destination UE2, wherein RB1 of the destination UE1 corresponds to a PC5-PDCP entity PC5-PDCP1 of the source UE, and RB2 of the destination UE2 corresponds to a PC5-PDCP entity PC5-PDCP2 of the source UE, an SRAP layer of the source UE determines that PC5-PDCP1 and PC5-PDCP2 correspond to different egress RLC channels. Therefore, a data packet of RB1 of the destination UE1 and a data packet of RB2 of the destination UE2 are transmitted to different egress RLC channels.

1002, the source UE transmits via the determined egress RLC channel to a relay terminal equipment, a first data packet that is transmitted by the source terminal equipment to the destination terminal equipment, the first data packet including data transmitted by the source terminal equipment to the destination terminal equipment,
wherein the first data packet may include data transmitted by the source terminal equipment to the destination terminal equipment, the identifier able to be mapped to the destination terminal equipment, and the radio bearer identifier. For example the description is made by taking the destination UE1 and the destination UE2 as an example, as shown in FIG. 11, corresponding to the destination UE1, the first data packet includes data1, and may further include DST1 and RB 1; corresponding to the destination UE2, the first data packet includes data2, and may further include DST2 and RB 2.

1003, a relay UE receives the first data packet transmitted by the source terminal equipment to the destination terminal equipment.

PC5-PHY of the relay UE receives Sidelink control Information (SCI) transmitted by the source UE, a PC5-MAC layer of the relay UE receives an MAC PDU transmitted by the source UE and parses the MAC PDU to obtain an identifier able to be mapped to a destination terminal equipment corresponding to the first data packet, and a logical channel identifier.

The PC5-MAC layer of the relay terminal equipment determines an ingress RLC channel with which the logical channel of the destination terminal equipment is associated according to the identifier able to be mapped to the destination terminal equipment included in the MAC PDU, the logical channel identifier, and second configuration information.

The ingress RLC channel of the relay equipment transmits the first data packet of the destination terminal equipment to an SRAP receiving entity.

1004, the relay UE determines an egress RLC channel to which the destination terminal equipment corresponds, wherein egress RLC channels to which different destination terminal equipments correspond are different,
wherein the relay terminal equipment determines the egress RLC channel with which the RB of the destination terminal equipment is associated according to the identifier able to be mapped to the destination terminal equipment, the radio bearer identifier and first configuration information.

For example, as shown in FIG. 11, the SRAP transmitting entity of the relay UE determines an egress RLC channel (PC5-RLC1) with which an RB of the destination UE1 is associated according to the identifier (DST1) able to be mapped to the destination UE1, the radio bearer identifier (RB1), and the first configuration information. The SRAP transmitting entity of the relay UE determines an egress RLC channel (PC5-RLC2) with which an RB of the destination UE2 is associated according to the identifier (DST2) able to be mapped to the destination UE2, the radio bearer identifier (RB2), and the first configuration information.

1005, the relay UE transmits a second data packet to the destination terminal equipment via the determined egress RLC channel, the second data packet including data transmitted by the source terminal equipment to the destination terminal equipment.

In this embodiment, before 1005, the method may further include (not shown in the figure): generating a second data packet transmitted to different destination terminal equipments.

For example, as shown in FIG. 11, the relay terminal equipment receives from the source terminal equipment the first data packet transmitted by the source terminal equipment to the destination UE1, a data header of the first data packet includes an identifier (DST1) able to be mapped to the destination terminal equipment 1. The relay terminal equipment changes the identifier (DST1) able to be mapped to the destination UE1 included in the data header of the first data packet as an identifier (SRC1) able to be mapped to the source terminal equipment. The relay terminal equipment receives from the source terminal equipment the first data packet transmitted by the source terminal equipment to the destination UE2, a data header of the first data packet includes an identifier (DST2) able to be mapped to the destination UE2. The relay terminal equipment changes the identifier (DST2) able to be mapped to the destination terminal equipment 2 included in the data header of the first data packet as an identifier (SRC2) able to be mapped to the source terminal equipment. Accordingly, the second data packet may be generated. In addition, the second data packet not only includes data transmitted by the source terminal equipment to the destination terminal equipment, but also may include an identifier able to be mapped to the source terminal equipment, and a radio bearer identifier.

When source terminal equipments that transmit the first data packet to the destination terminal equipment 1 and the destination terminal equipment 2 are identical, the identifier (SRC1) able to be mapped to the source terminal equipment and the identifier (SRC2) able to be mapped to the source terminal equipment are identical. When source terminal equipments that transmit the first data packet to the destination terminal equipment 1 and the destination terminal equipment 2 are different, the identifier (SRC1) able to be mapped to the source terminal equipment and the identifier (SRC2) able to be mapped to the source terminal equipment are different.

1006, the destination UE determines an ingress RLC channel to which the destination terminal equipment corresponds;
wherein the destination UE determines the egress RLC channel with which the RB of the destination terminal equipment is associated according to the identifier able to be mapped to the source terminal equipment, the radio bearer identifier, and fifth configuration information.

For example, as shown in FIG. 11, operations of receiving data by MAC layers of the destination UE1 and the destination UE2 are similar to operations of receiving data by the MAC layer of the relay UE.

1007, the destination UE receives the second data packet via the determined ingress RLC channel.

As may be known from the above embodiment, in the UE to UE relay, multiplexing of data of different destination terminal equipments to the same RLC channel may not be supported, and in the case of not supporting multiplexing, the source UE may transmit data to different destination UEs via different egress RLC channels. The relay UE may receive data transmitted by the source UE to different destination UEs via different ingress channels, and transmit data transmitted by the source UE to different destination UEs via different egress RLC channels. The relay terminal equipment may distinguish data transmitted by the source UE to different destination UEs and transmit the same via different egress RLC channels.

As may be known from the above embodiment, in the UE to UE relay, multiplexing of data of different destination terminal equipments to the same RLC channel may not be supported, and in the case of not supporting multiplexing, the source UE may transmit data to at least two different destination UEs via different egress RLC channels. The relay UE may receive data transmitted by the source UE to different destination UEs via different ingress channels, and transmit data transmitted by the source UE to different destination UEs via different egress RLC channels.

In this embodiment, implementation and nouns explanation of steps 1000 to 1002 are similar to the contents of the embodiments in the third aspect of the present disclosure. The above-mentioned relevant contents are combined here and are not repeated here.

Implementation and nouns explanation of steps 1003 to 1005 are similar to the contents of the embodiments in the first aspect of the present disclosure. The above-mentioned relevant contents are combined here and are not repeated here.

Implementation and nouns explanation of steps 1006 to 1007 are similar to the contents of the embodiments in the fourth aspect of the present disclosure. The above-mentioned relevant contents are combined here and are not repeated here.

Each of the above embodiments is only illustrative for the embodiments of the present disclosure, but the present disclosure is not limited to this, appropriate modifications may be further made based on the above each embodiment. For example, each of the above embodiments may be used individually, or one or more of the above embodiments may be combined.

It's worth noting that the above text only describes steps related to the present disclosure, but the present disclosure is not limited thereto. The method for receiving data in the present disclosure may further include other steps. For specific contents of these steps, relevant technologies may be referred to.

Each of the above embodiments is only illustrative for the embodiments of the present disclosure, but the present disclosure is not limited to this, appropriate modifications may be further made based on the above each embodiment. For example, each of the above embodiments may be used individually, or one or more of the above embodiments may be combined.

### Embodiments of a Seventh Aspect

Embodiments of the present disclosure provide an apparatus for receiving and transmitting data, configured in a relay terminal equipment. The apparatus for receiving and transmitting data and the method for receiving and transmitting data in the embodiments of the first aspect provided by the present disclosure are produced based on the same inventive concept, and their principles for solving problems are similar. Therefore, for implementation of the apparatus for receiving and transmitting data, refer to implementation of the method for receiving and transmitting data in the embodiments of the first aspect provided by the present disclosure, repetitions are not elaborated further. As used below, the term “unit” or “module” may be a combination of software and/or hardware that implements a predetermined function. Although the system described in the following embodiments is better implemented in software, implementation of hardware or a combination of software and hardware may also be possible and conceived.

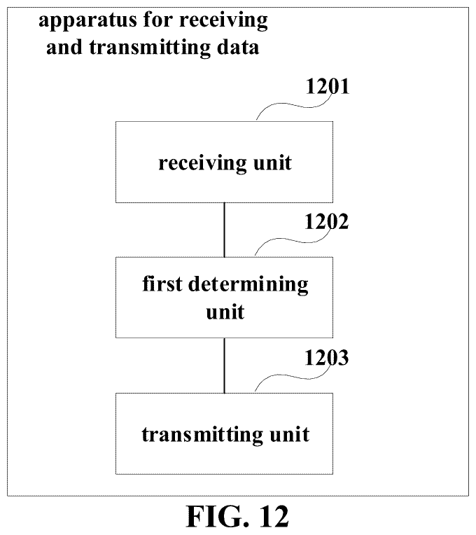

As shown in FIG. 12, the apparatus includes:
a receiving unit 1201 configured to receive a first data packet transmitted by a source terminal equipment to a destination terminal equipment, the first data packet including data transmitted by the source terminal equipment to the destination terminal equipment;
a first determining unit 1202 configured to determine a first egress RLC channel to which the destination terminal equipment corresponds, wherein first egress RLC channels to which different destination terminal equipments correspond are different; and
a transmitting unit 1203 configured to transmit a second data packet to the destination terminal equipment via the determined first egress RLC channel, the second data packet including the data.

In some embodiments, the first determining unit is used to:
determine a first egress RLC channel with which a radio bearer (RB) of the destination terminal equipment is associated, RBs of different destination terminal equipments being associated with different first egress RLC channels.

In some embodiments, the first data packet further includes an identifier able to be mapped to the destination terminal equipment and a radio bearer identifier;
the first determining unit is used to:
determine the first egress RLC channel with which the RB of the destination terminal equipment is associated according to the identifier able to be mapped to the destination terminal equipment, the radio bearer identifier and first configuration information.

In some embodiments, the first configuration information includes an egress RLC channel with which the RB of the destination terminal equipment is associated, or an RB of the destination terminal equipment with which an egress RLC channel is associated.

In some embodiments, the identifier able to be mapped to the destination terminal equipment includes an L2 identifier of the source terminal equipment, or an L2 identifier of the destination terminal equipment, or an L2 identifier pair of the source terminal equipment and the destination terminal equipment, or a local identifier of the source terminal equipment, or a local identifier of the destination terminal equipment, or a local identifier pair of the source terminal equipment and the destination terminal equipment, or a local identifier of a pair of the source terminal equipment and the destination terminal equipment.

In some embodiments, the first configuration information is from a network device, and/or from a source terminal equipment, and/or from pre-configuration of a relay terminal equipment.

In some embodiments, the first data packet transmitted to the destination terminal equipment is transmitted by the source terminal equipment via the same second egress RLC channel.

In some embodiments, the first data packet transmitted to the destination terminal equipment is transmitted by the source terminal equipment via different second egress RLC channels.

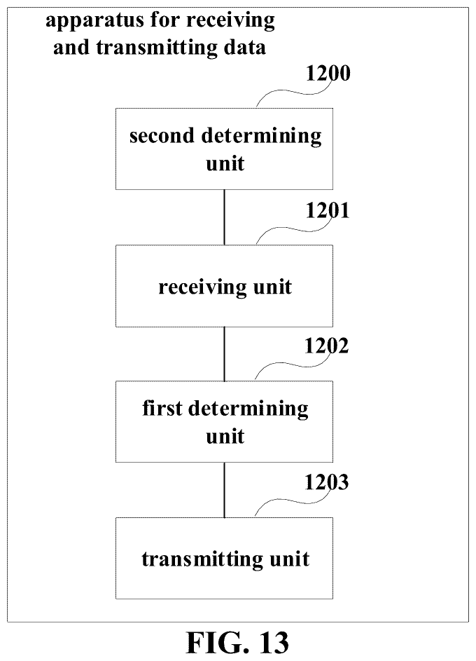

In some embodiments, as shown in FIG. 13, the apparatus further includes a second determining unit 1200 configured to:
determine an ingress RLC channel receiving the first data packet according to an L2 identifier of the source terminal equipment and/or an L2 identifier of the destination terminal equipment, a logical channel identifier and second configuration information.

In some embodiments, the second configuration information includes an ingress RLC channel with which a logical channel of the source terminal equipment and/or the destination terminal equipment is associated, or a logical channel of the source terminal equipment and/or the destination terminal equipment with which the ingress RLC channel is associated.

In some embodiments, the second configuration information is from a network device, and/or from a source terminal equipment, and/or from pre-configuration of a relay terminal equipment.

In some embodiments, the receiving unit is used to:
receive a first data packet transmitted by the source terminal equipment to the destination terminal equipment via the determined ingress RLC channel.

In some embodiments, the apparatus further includes a third determining unit configured to:
determine an ingress RLC channel receiving the first data packet according to an L2 identifier of the source terminal equipment and/or an L2 identifier of the destination terminal equipment and a logical channel identifier.

In some embodiments, the second data packet further includes an identifier able to be mapped to the source terminal equipment.

In some embodiments, the identifier able to be mapped to the source terminal equipment includes an L2 identifier of the source terminal equipment, or an L2 identifier of the destination terminal equipment, or an L2 identifier pair of the source terminal equipment and the destination terminal equipment, or a local identifier of the source terminal equipment, or a local identifier of the destination terminal equipment, or a local identifier pair of the source terminal equipment and the destination terminal equipment, or a local identifier of a pair of the source terminal equipment and the destination terminal equipment.

Moreover, for the sake of simplicity, FIG. 12 and FIG. 13 only exemplarily show a connection relationship or signal direction between components or modules, however persons skilled in the art should know that various relevant technologies such as bus connection can be used. The above components or modules may be realized by a hardware facility such as a processor, a memory, a transmitter, a receiver, etc. The embodiments of the present disclosure have no limitation to this.

According to each of the above embodiments, for data transmitted by the source terminal equipment to different destination terminal equipments, the relay terminal equipment respectively transmits the data to a corresponding destination terminal equipment via different egress RLC channels. During a UE-to-UE relay process, in the case of supporting multiplexing of data of different destination terminal equipments to the same RLC channel, and in the case of not supporting multiplexing of data of different destination terminal equipments to the same RLC channel, the relay terminal equipment is able to transmit data transmitted from the source terminal equipment to different destination terminal equipments to a corresponding destination terminal. Especially in the case of supporting multiplexing of data of different destination terminal equipments to the same RLC channel, through the method in the above embodiments, the number of PC5-RLC channels may be saved, the capability requirements for a UE may be reduced, and the processing complexity of the UE may be decreased.

### Embodiments of an Eighth Aspect

Embodiments of the present disclosure provide an apparatus for transmitting data, configured in a source terminal equipment. The apparatus for transmitting data and the method for transmitting data in the embodiments of the second aspect provided by the present disclosure are produced based on the same inventive concept, and their principles for solving problems are similar. Therefore, for implementation of the apparatus for transmitting data, refer to implementation of the method for transmitting data in the embodiments of the first aspect provided by the present disclosure, repetitions are not elaborated further. As used below, the term “unit” or “module” may be a combination of software and/or hardware that implements a predetermined function. Although the system described in the following embodiments is better implemented in software, implementation of hardware or a combination of software and hardware may also be possible and conceived.

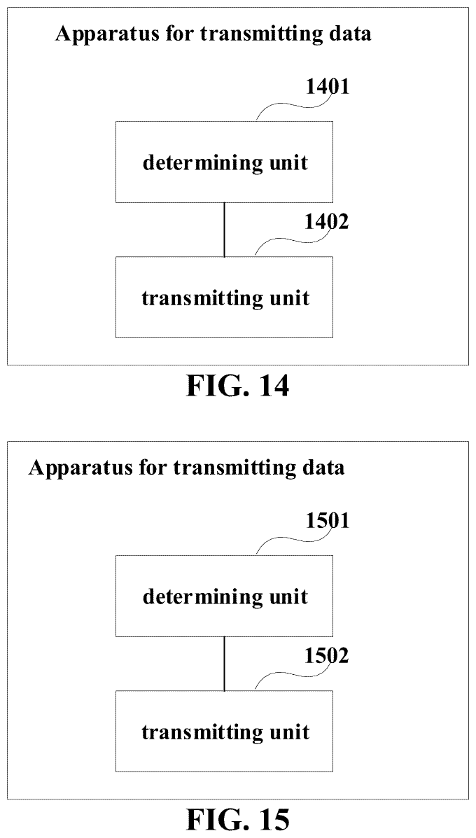

As shown in FIG. 14, the apparatus includes:
a determining unit 1401 configured to determine a second egress RLC channel to which a destination terminal equipment corresponds, wherein different destination terminal equipments correspond to the same second egress RLC channel; and
a transmitting unit 1402 configured to transmit via the determined second egress RLC channel to a relay terminal equipment, a data packet that is transmitted by the source terminal equipment to different destination terminal equipments, the data packet including data transmitted by the source terminal equipment to the destination terminal equipment.

In some embodiments, the determining unit is used to:
determine a second egress RLC channel with which an RB of the destination terminal equipment is associated, wherein RBs of at least two destination terminal equipments are associated with the same second egress RLC channel.

In some embodiments, the determining unit is used to:
determine a second egress RLC channel to which the destination terminal equipment corresponds according to third configuration information, the third configuration information including the second egress RLC channel with which the RB of the destination terminal equipment is associated, or the RB of the destination terminal equipment with which the second egress RLC channel is associated.

In some embodiments, the third configuration information is from a network device, and/or from a relay terminal equipment, and/or from pre-configuration of the source terminal equipment.

Moreover, for the sake of simplicity, FIG. 14 only exemplarily shows a connection relationship or signal direction between components or modules, however persons skilled in the art should know that various relevant technologies such as bus connection may be used. The above components or modules may be realized by a hardware facility such as a processor, a memory, a transmitter, a receiver, etc. The embodiments of the present disclosure have no limitation to this.

According to the above embodiment, the source terminal equipment transmits a data packet to different (at least two) destination terminal equipments via the same egress RLC channel, and supports multiplexing data of different destination terminal equipments to the same RLC channel, which may save the number of PC5-RLC channel, reduce the capability requirements for the UE, and decrease the processing complexity of the UE.

### Embodiments of a Ninth Aspect

Embodiments of the present disclosure provide an apparatus for transmitting data, configured in a source terminal equipment. The apparatus for transmitting data and the method for transmitting data in the embodiments of the third aspect provided by the present disclosure are produced based on the same inventive concept, and their principles for solving problems are similar. Therefore, for implementation of the apparatus for transmitting data, refer to implementation of the method for transmitting data in the embodiments of the first aspect provided by the present disclosure, repetitions are not elaborated further. As used below, the term “unit” or “module” may be a combination of software and/or hardware that implements a predetermined function. Although the system described in the following embodiments is better implemented in software, implementation of hardware or a combination of software and hardware may also be possible and conceived.

As shown in FIG. 15, the apparatus includes:
a determining unit 1501 configured to determine a third egress RLC channel to which a destination terminal equipment corresponds, wherein different destination terminal equipments correspond to different third egress RLC channels; and
a transmitting unit 1502 configured to transmit via the determined third egress RLC channel to a relay terminal equipment, a data packet that is transmitted by the source terminal equipment to the destination terminal equipment,
wherein the data packet includes data transmitted by the source terminal equipment to the destination terminal equipment and a radio bearer identifier, but does not include an identifier able to be mapped to the destination terminal equipment.

In some embodiments, the identifier able to be mapped to the destination terminal equipment includes an L2 identifier of the source terminal equipment, or an L2 identifier of the destination terminal equipment, or an L2 identifier pair of the source terminal equipment and the destination terminal equipment, or a local identifier of the source terminal equipment, or a local identifier of the destination terminal equipment, or a local identifier pair of the source terminal equipment and the destination terminal equipment, or a local identifier of a pair of the source terminal equipment and the destination terminal equipment.

Moreover, for the sake of simplicity, FIG. 15 only exemplarily shows a connection relationship or signal direction between components or modules, however persons skilled in the art should know that various relevant technologies such as bus connection may be used. The above components or modules may be realized by a hardware facility such as a processor, a memory, a transmitter, a receiver, etc. The embodiments of the present disclosure have no limitation to this.

According to the above embodiment, the source terminal equipments respectively transmit a data packet to different destination terminal equipments via the different egress RLC channels, and do not support multiplexing data of different destination terminal equipments to the same RLC channel. In a first hop, in a data packet transmitted from the source terminal equipment to the destination terminal equipment, the identifier able to be mapped to the destination terminal equipment may not appear to save overhead.

### Embodiments of a Tenth Aspect

Embodiments of the present disclosure provide an apparatus for receiving data, configured in a destination terminal equipment. The apparatus for receiving data and the method for receiving data in the embodiments of the fourth aspect provided by the present disclosure are produced based on the same inventive concept, and their principles for solving problems are similar. Therefore, for implementation of the apparatus for receiving data, refer to implementation of the method for receiving data in the embodiments of the first aspect provided by the present disclosure, repetitions are not elaborated further. As used below, the term “unit” or “module” may be a combination of software and/or hardware that implements a predetermined function. Although the system described in the following embodiments is better implemented in software, implementation of hardware or a combination of software and hardware may also be possible and conceived.

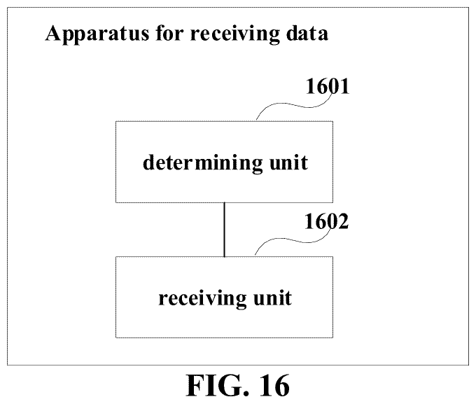

As shown in FIG. 16, the apparatus includes:
a determining unit 1601, a destination terminal equipment determines an ingress RLC channel receiving the second data packet, the second data packet including data transmitted by the source terminal equipment to the destination terminal equipment;
a receiving unit 1602 configured to receive the second data packet via the determined second ingress RLC channel;
wherein the second data packet includes data transmitted by the source terminal equipment to the destination terminal equipment and a radio bearer identifier, but does not include an identifier able to be mapped to the destination terminal equipment, or the data packet does not include an identifier able to be mapped to the destination terminal equipment; or, the data packet includes data transmitted by the source terminal equipment to the destination terminal equipment, an identifier able to be mapped to the destination terminal equipment, and a radio bearer identifier, but in another embodiment, the identifier able to be mapped to the destination terminal equipment is default.

In some embodiments, the second data packet further includes an identifier able to be mapped to the source terminal equipment.

In one embodiment, the identifier able to be mapped to the source terminal equipment includes an L2 identifier of the source terminal equipment, or an L2 identifier of the destination terminal equipment, or an L2 identifier pair of the source terminal equipment and the destination terminal equipment, or a local identifier of the source terminal equipment, or a local identifier of the destination terminal equipment, or a local identifier pair of the source terminal equipment and the destination terminal equipment, or a local identifier of a pair of the source terminal equipment and the destination terminal equipment.

In one embodiment, the determining unit is used to:
determine an ingress RLC channel with which an RB of the destination terminal equipment is associated.

In one embodiment, the second data packet further includes an identifier able to be mapped to the destination terminal equipment and a radio bearer identifier (Radio Bearer ID, RB ID);
the determining unit is used to:
determine an ingress RLC channel with which the RB of the destination terminal equipment is associated according to the identifier able to be mapped to the destination terminal equipment, the radio bearer identifier and fourth configuration information.

In one embodiment, the first configuration information includes an ingress RLC channel with which the RB of the destination terminal equipment is associated, or an RB of the destination terminal equipment with which an ingress RLC channel is associated.

For example, the fourth configuration information includes an ingress RLC channel with which RBs of different destination terminal equipments are associated, an RB of one destination terminal equipment is associated with one ingress RLC channel; or
the fourth configuration information includes an RB of the destination terminal equipment with which an ingress RLC channel is associated, one ingress RLC channel is associated with an RB of one destination terminal equipment.

In one embodiment, the fourth configuration information is from a network device, and/or from a source terminal equipment, and/or from pre-configuration of a relay terminal equipment.

In some embodiments, the ingress RLC channel with which the RB of the destination terminal equipment is associated is determined according to the identifier able to be mapped to the destination terminal equipment and the radio bearer identifier.

It's worth noting that the above only describes components or modules related to the present disclosure, but the present disclosure is not limited to this. The apparatus for transmitting and receiving data may further include other components or modules. For specific contents of these components or modules, FIG. 16 only exemplarily shows a connection relationship or signal direction between components or modules, however persons skilled in the art should know that various relevant technologies such as bus connection may be used. The above components or modules may be realized by a hardware facility such as a processor, a memory, a transmitter, a receiver, etc. The embodiments of the present disclosure have no limitation to this.

Each of the above embodiments is only illustrative for the embodiments of the present disclosure, but the present disclosure is not limited to this, appropriate modifications may be further made based on the above each embodiment. For example, each of the above embodiments may be used individually, or one or more of the above embodiments may be combined.

### Embodiments of an Eleventh Aspect

Embodiments of the present disclosure provide a communication system, FIG. 2 may be referred to, the communication system includes a source terminal equipment 201, a relay terminal equipment 203 and a destination terminal equipment 202.

In the embodiments of the present disclosure, the source terminal equipment 201 is configured to perform the method for transmitting data in the second and/or third aspects of the present disclosure, its contents are incorporated here and are not elaborated here.

In the embodiments of the present disclosure, the relay terminal equipment 203 is configured to perform the method for transmitting and receiving data in the first aspect of the present disclosure, its contents are incorporated here and are not elaborated here.

In the embodiments of the present disclosure, the destination terminal equipment 202 is configured to perform the method for receiving data in the fourth aspect of the present disclosure, its contents are incorporated here and are not elaborated here.

### Embodiments of a Twelfth Aspect

Embodiments of the present disclosure provide a terminal equipment.

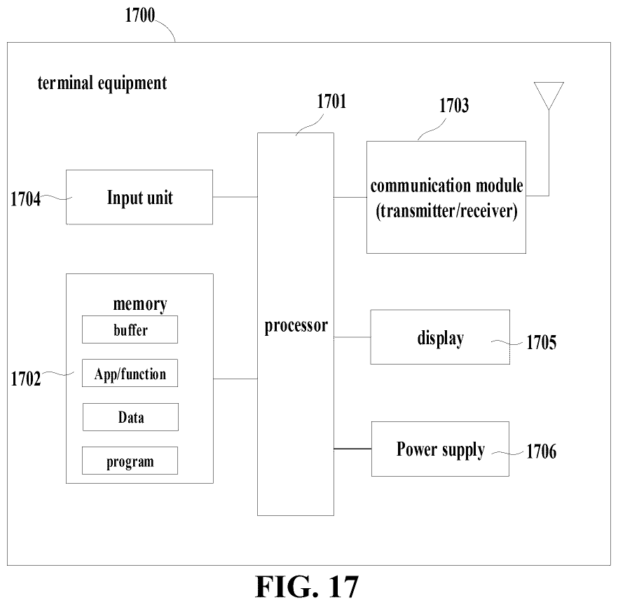

FIG. 17 is a schematic diagram of composition of a terminal equipment in embodiments of the present disclosure, the terminal equipment may be a remote terminal equipment. As shown in FIG. 17, a terminal equipment 1700 may include a processor 1701 and a memory 1702; the memory 1702 stores data and programs, and is coupled to the processor 1701. It's worth noting that this figure is exemplary; other types of structures can also be used to supplement or replace this structure, so as to realize a telecommunication function or other functions.

For example, the processor 1701 may be configured to execute a program to implement the method for receiving and transmitting data as described in the embodiments of the first aspect. For example, the processor 1701 may be configured to perform the following operations: receiving a first data packet transmitted by a source terminal equipment to a destination terminal equipment, the first data packet including data transmitted by the source terminal equipment to the destination terminal equipment; determining a first egress RLC channel to which the destination terminal equipment corresponds, wherein first egress RLC channels to which different destination terminal equipments correspond are different; and transmitting a second data packet to the destination terminal equipment via the determined first egress RLC channel, the second data packet including the data.

For another example, the processor 1701 may be configured to execute a program to implement the method for transmitting data as described in the embodiments of the second aspect. For example, the processor 1701 may be configured to perform the following operations: determining a second egress RLC channel corresponding to the destination terminal equipment; wherein different destination terminal equipments correspond to the same second egress RLC channel; transmitting via the determined second egress RLC channel to a relay terminal equipment, a data packet that is transmitted by the source terminal equipment to different destination terminal equipments, the data packet including data transmitted by the source terminal equipment to the destination terminal equipment.

For another example, the processor 1701 may be configured to execute a program to implement the method for transmitting data as described in the embodiments of the third aspect. For example, the processor 1701 may be configured to perform the following operations: determining a third egress RLC channel corresponding to the destination terminal equipment; wherein different destination terminal equipments correspond to different third egress RLC channels; transmitting via the determined third egress RLC channel to a relay terminal equipment, a data packet that is transmitted by the source terminal equipment to destination terminal equipments, wherein the data packet includes data transmitted by the source terminal equipment to the destination terminal equipment, and a radio bearer identifier but does not include an identifier able to be mapped to the destination terminal equipment.

For another example, the processor 1701 may be configured to execute a program to implement the method for receiving data as described in the embodiments of the fourth aspect. For example, the processor 1701 may be configured to perform the following operations: determining a second ingress RLC channel receiving a second data packet, the second data packet including data transmitted from a source terminal equipment to a destination terminal equipment; and receiving the second data packet via the determined second ingress RLC channel.

As shown in FIG. 17, the terminal equipment 1700 may further include: a communication module 1703, an input unit 1704, a display 1705 and a power supply 1706. The functions of said components are similar to related arts, which are not repeated here. It's worth noting that the terminal equipment 1700 does not have to include all the components shown in FIG. 17, said components are not indispensable. Moreover, the terminal equipment 1700 may also include components not shown in FIG. 17, relevant technologies can be referred to.

Embodiments of the present disclosure further provide a computer readable program, wherein when a relay terminal equipment executes the program, the program enables a computer to execute the method for receiving and transmitting data described in the embodiments of the first aspect, in the relay terminal equipment.

Embodiments of the present disclosure further provide a storage medium in which a computer readable program is stored, wherein the computer readable program enables a computer to execute the method for receiving and transmitting data as described in the embodiments of the first aspect of the present disclosure, in a relay terminal equipment.

Embodiments of the present disclosure further provide a computer readable program, wherein when a source terminal equipment executes the program, the program enables a computer to execute the method for transmitting data described in the embodiments of the second aspect and/or the method for transmitting data described in the embodiments of the third aspect of the present disclosure, in the source terminal equipment.

Embodiments of the present disclosure further provide a storage medium in which a computer readable program is stored, wherein the computer readable program enables a computer to execute the method for transmitting data as described in the embodiments of the second aspect and/or the method for transmitting data described in the embodiments of the third aspect of the present disclosure, in a source terminal equipment.

Embodiments of the present disclosure further provide a computer readable program, wherein when a source terminal equipment executes the program, the program enables a computer to execute the method for receiving data described in the embodiments of the third aspect, in the source terminal equipment.

Embodiments of the present disclosure further provide a storage medium in which a computer readable program is stored, wherein the computer readable program enables a computer to execute the method for transmitting and receiving data as described in the embodiments of the third aspect of the present disclosure, in a source terminal equipment.

The apparatus and method in the present disclosure may be realized by hardware, or may be realized by combining hardware with software. The present disclosure relates to such a computer readable program, when the program is executed by a logic component, the computer readable program enables the logic component to realize the device described in the above text or a constituent component, or enables the logic component to realize various methods or steps described in the above text. The present disclosure further relates to a storage medium storing the program, such as a hard disk, a magnetic disk, an optical disk, a DVD, a flash memory and the like.

By combining with the method/device described in the embodiments of the present disclosure, it may be directly reflected as hardware, a software executed by a processor, or a combination of the two. For example, one or more in the functional block diagram or one or more combinations in the functional block diagram as shown in the drawings may correspond to software modules of a computer program flow, and may also correspond to hardware modules. These software modules may respectively correspond to the steps as shown in the drawings. These hardware modules may be realized by solidifying these software modules e.g. using a field-programmable gate array (FPGA).

A software module may be located in a RAM memory, a flash memory, a ROM memory, an EPROM memory, an EEPROM memory, a register, a hard disk, a mobile magnetic disk, a CD-ROM or a storage medium in any other form as known in this field. A storage medium may be coupled to a processor, thereby enabling the processor to read information from the storage medium, and to write the information into the storage medium; or the storage medium may be a constituent part of the processor. The processor and the storage medium may be located in an ASIC. The software module may be stored in a memory of a mobile terminal, and may also be stored in a memory card of the mobile terminal. For example, if a device (such as the mobile terminal) adopts a MEGA-SIM card with a larger capacity or a flash memory apparatus with a large capacity, the software module may be stored in the MEGA-SIM card or the flash memory apparatus with a large capacity.

One or more in the functional block diagram or one or more combinations in the functional block diagram as described in the drawings may be implemented as a general-purpose processor for performing the functions described in the present disclosure, a digital signal processor (DSP), an application-specific integrated circuit (ASIC), a field-programmable gate array (FPGA) or other programmable logic device, discrete gate or transistor logic device, discrete hardware components or any combination thereof. One or more in the functional block diagram or one or more combinations in the functional block diagram as described in the drawings may further be implemented as a combination of computer equipments, such as a combination of a DSP and a microprocessor, a plurality of microprocessors, one or more microprocessors combined and communicating with the DSP or any other such configuration.

The present disclosure is described by combining with the specific implementations, however persons skilled in the art should clearly know that these descriptions are exemplary and do not limit the protection scope of the present disclosure. Persons skilled in the art may make various variations and modifications to the present disclosure according to the spirit and principle of the present disclosure, these variations and modifications are also within the scope of the present disclosure.

As for the implementations including the above embodiments, the following supplements are further disclosed:

### A Method for Receiving and Transmitting Data at a Relay Terminal Equipment Side

1. A method for receiving and transmitting data, applicable to a relay terminal equipment, the method including:
receiving a first data packet transmitted by a source terminal equipment to a destination terminal equipment, the first data packet including data transmitted by the source terminal equipment to the destination terminal equipment;
determining a first egress RLC channel to which the destination terminal equipment corresponds, wherein first egress RLC channels to which different destination terminal equipments correspond are different; and
transmitting a second data packet to the destination terminal equipment via the determined first egress RLC channel, the second data packet including the data.

2. The method according to supplement 1, wherein the determining a first egress RLC channel to which the destination terminal equipment corresponds includes: determining a first egress RLC channel with which a radio bearer (RB) of the destination terminal equipment is associated, RBs of different destination terminal equipments being associated with different first egress RLC channels.

3. The method according to supplement 2, wherein the first data packet further includes an identifier able to be mapped to the destination terminal equipment and a radio bearer identifier; and/or
the determining a first egress RLC channel with which an RB of the destination terminal equipment is associated includes:
determining the first egress RLC channel with which the RB of the destination terminal equipment is associated according to the identifier able to be mapped to the destination terminal equipment and the radio bearer identifier.

4. The method according to supplement 2, wherein the first data packet further includes an identifier able to be mapped to the destination terminal equipment and a radio bearer identifier; and/or
the determining a first egress RLC channel with which an RB of the destination terminal equipment is associated includes:
determining the first egress RLC channel with which the RB of the destination terminal equipment is associated according to the identifier able to be mapped to the destination terminal equipment, the radio bearer identifier and first configuration information,
the first configuration information including an egress RLC channel with which the RB of the destination terminal equipment is associated, or an RB of the destination terminal equipment with which an egress RLC channel is associated.

5. The method according to supplement 3, wherein the identifier able to be mapped to the destination terminal equipment includes an L2 identifier of the source terminal equipment, or an L2 identifier of the destination terminal equipment, or an L2 identifier pair of the source terminal equipment and the destination terminal equipment, or a local identifier of the source terminal equipment, or a local identifier of the destination terminal equipment, or a local identifier pair of the source terminal equipment and the destination terminal equipment, or a local identifier of a pair of the source terminal equipment and the destination terminal equipment.

6. The method according to supplement 4, wherein the first configuration information is from a network device, and/or from the source terminal equipment, and/or from pre-configuration of the relay terminal equipment.

7. The method according to supplement 1, wherein the first data packet transmitted to the destination terminal equipment is transmitted by the source terminal equipment via the same second egress RLC channel.

8. The method according to supplement 1, wherein the first data packet transmitted to the destination terminal equipment is transmitted by the source terminal equipment via different second egress RLC channels.

9a. The method according to supplement 1, wherein the method further includes:
determining an ingress RLC channel receiving the first data packet.

9b. The method according to supplement 9a, wherein the determining an ingress RLC channel receiving the first data packet includes:
determining an ingress RLC channel with which a logical channel of the destination terminal equipment is associated.

9. The method according to supplement 9b, wherein the determining an ingress RLC channel with which a logical channel of the destination terminal equipment is associated includes:
determining the ingress RLC channel receiving the first data packet according to an identifier able to be mapped to the destination terminal equipment, a logical channel identifier and second configuration information.

10. The method according to supplement 9, wherein the second configuration information includes an ingress RLC channel with which a logical channel of the destination terminal equipment is associated, or a logical channel of the destination terminal equipment with which the ingress RLC channel is associated.

10a. The method according to supplement 9, wherein the identifier able to be mapped to the destination terminal equipment includes:
an L2 identifier of the source terminal equipment, or an L2 identifier of the destination terminal equipment, or an L2 identifier pair of the source terminal equipment and the destination terminal equipment, or a local identifier of the source terminal equipment, or a local identifier of the destination terminal equipment, or a local identifier pair of the source terminal equipment and the destination terminal equipment, or a local identifier of a pair of the source terminal equipment and the destination terminal equipment.

11. The method according to supplement 9, wherein the second configuration information is from a network device, and/or from the source terminal equipment, and/or from pre-configuration of the relay terminal equipment.

12. The method according to supplement 9a, wherein that the receiving the first data packet transmitted by the source terminal equipment to the destination terminal equipment includes:
receiving a first data packet transmitted by the source terminal equipment to the destination terminal equipment via the determined ingress RLC channel.

13. The method according to supplement 9a, wherein the method further includes:
determining the ingress RLC channel receiving the first data packet according to an identifier able to be mapped to the destination terminal equipment and a logical channel identifier.

13a. The method according to supplement 13, wherein the identifier able to be mapped to the destination terminal equipment includes:
an L2 identifier of the source terminal equipment, or an L2 identifier of the destination terminal equipment, or an L2 identifier pair of the source terminal equipment and the destination terminal equipment, or a local identifier of the source terminal equipment, or a local identifier of the destination terminal equipment, or a local identifier pair of the source terminal equipment and the destination terminal equipment, or a local identifier of a pair of the source terminal equipment and the destination terminal equipment.

14. The method according to supplement 1, wherein the second data packet further includes an identifier able to be mapped to the source terminal equipment.

15. The method according to supplement 14, wherein the identifier able to be mapped to the source terminal equipment includes: an L2 identifier of the source terminal equipment, or an L2 identifier of the destination terminal equipment, or an L2 identifier pair of the source terminal equipment and the destination terminal equipment, or a local identifier of the source terminal equipment, or a local identifier of the destination terminal equipment, or a local identifier pair of the source terminal equipment and the destination terminal equipment, or a local identifier of a pair of the source terminal equipment and the destination terminal equipment.

### A Method for Transmitting Data at a Source Terminal Equipment Side

### (First Part)

16. A method for transmitting data, applicable to a source terminal equipment, the method including:
determining a second egress RLC channel to which a destination terminal equipment corresponds, wherein different destination terminal equipments correspond to the same second egress RLC channel; and
transmitting via the determined second egress RLC channel to a relay terminal equipment, a data packet that is transmitted by the source terminal equipment to different destination terminal equipments, the data packet including data transmitted by the source terminal equipment to the destination terminal equipment.

17. The method according to supplement 16, wherein the determining a second egress RLC channel to which a destination terminal equipment corresponds includes: determining a second egress RLC channel with which an RB of the destination terminal equipment is associated, wherein RBs of at least two destination terminal equipments are associated with the same second egress RLC channel.

18. The method according to supplement 17, wherein the determining a second egress RLC channel with which an RB of the destination terminal equipment is associated includes:
determining a second egress RLC channel to which the destination terminal equipment corresponds according to third configuration information, the third configuration information including the second egress RLC channel with which the RB of the destination terminal equipment is associated, or the RB of the destination terminal equipment with which the second egress RLC channel is associated.

19. The method according to supplement 18, wherein the third configuration information is from a network device, and/or from the relay terminal equipment, and/or from pre-configuration of the source terminal equipment.

### (Second Part)

20. A method for transmitting data, applicable to a source terminal equipment, the method including:
determining a third egress RLC channel to which a destination terminal equipment corresponds, wherein different destination terminal equipments correspond to different third egress RLC channels; and
transmitting via the determined third egress RLC channel to a relay terminal equipment, a data packet that is transmitted by the source terminal equipment to the destination terminal equipment;
wherein the data packet includes data transmitted by the source terminal equipment to the destination terminal equipment and a radio bearer identifier, but does not include an identifier able to be mapped to the destination terminal equipment.

21. The method according to supplement 20, wherein the identifier able to be mapped to the destination terminal equipment includes an L2 identifier of the source terminal equipment, or an L2 identifier of the destination terminal equipment, or an L2 identifier pair of the source terminal equipment and the destination terminal equipment, or a local identifier of the source terminal equipment, or a local identifier of the destination terminal equipment, or a local identifier pair of the source terminal equipment and the destination terminal equipment, or a local identifier of a pair of the source terminal equipment and the destination terminal equipment.

### Relay Terminal Equipment

22. A terminal equipment, including a memory and a processor, wherein the memory stores a computer program, and the processor is configured to execute the computer program to implement the method for receiving and transmitting data as described in any one of supplements 1-15.

### Source Terminal Equipment

23. A terminal equipment, including a memory and a processor, wherein the memory stores a computer program, and the processor is configured to execute the computer program to implement the method for transmitting data as described in any one of supplements 16-21.

### Communication System

24. A communication system, including:
a source terminal equipment configured to execute the method as described in any one of supplements 16-21;
a relay terminal equipment configured to execute the method as described in any one of supplements 1-15; and
a destination terminal equipment configured to receive a data packet transmitted by the relay terminal equipment.

What is claimed is:

1. An apparatus for receiving and transmitting data, configured in a relay terminal equipment, the apparatus comprising:
a receiver configured to receive a first data packet transmitted by a source terminal equipment to a destination terminal equipment, the first data packet comprising data transmitted by the source terminal equipment to the destination terminal equipment;
processor circuitry configured to determine a first egress RLC (Radio Link Control) channel according to mapping relationship of radio bearers (RBs) and egress RLC channels for a pair of the source terminal equipment and the destination terminal equipment configured by a first configuration information, wherein the first configuration information comprising an identifier of the source terminal equipment, an identifier of the destination terminal equipment, and mapping relationship information of radio bearers (RBs) and egress RLC channels corresponding to the pair of the source terminal equipment and the destination terminal equipment; and
a transmitter configured to transmit a second data packet to the destination terminal equipment via the determined first egress RLC channel, the second data packet comprising the data.

2. The apparatus according to claim 1, wherein the receiver is further configured to receive the first configuration information from a network device.

3. The apparatus according to claim 1, wherein the mapping relationship information comprising RB IDs and RLC channel IDs.

4. The apparatus according to claim 1, wherein the first data packet transmitted by the source terminal equipment to the destination terminal equipment and received by the receiver is transmitted by the source terminal equipment via a second egress RLC channels.

5. The apparatus according to claim 4, wherein RBs towards the same destination terminal equipment and/or different destination terminal equipments are supported to be multiplexed to same second egress RLC channel.

6. The apparatus according to claim 3, the RB ID comprising DRB (Data Radio Bearer) ID and/or SRB (Signalling Radio Bearer) ID.

7. The apparatus according to claim 1, wherein the different RBs of the same source terminal equipment and/or the different RBs of different source terminal equipments are supported to be multiplexed to the same first egress RLC channel in between the relay terminal equipment and the destination terminal equipment.

8. An apparatus for receiving and transmitting data, configured in a destination terminal equipment, the apparatus comprising:
a receiver configured to receive a second data packet transmitted by relay terminal equipment via a first egress RLC (Radio Link Control) channel, the second data packet comprising the data transmitted by a source terminal equipment to the destination terminal equipment;
wherein the first egress RLC channel being determined by the relay terminal equipment according to mapping relationship of radio bearers (RBs) and egress RLC channels for a pair of the source terminal equipment and the destination terminal equipment configured by a first configuration information, wherein the first configuration information comprising an identifier of the source terminal equipment, an identifier of the destination terminal equipment, and mapping relationship information of radio bearers (RBs) and egress RLC channels corresponding to the pair of the source terminal equipment and the destination terminal equipment.

9. The apparatus according to claim 8, where the mapping relationship information comprising RB IDs and RLC channel IDs.

10. The apparatus according to claim 9, the RB ID comprising DRB (Data Radio Bearer) ID and/or SRB (Signalling Radio Bearer) ID.

11. The apparatus according to claim 8, wherein the different RBs of the same source terminal equipment and/or the different RBs of different source terminal equipments are supported to be multiplexed to the same first egress RLC channel in between the relay terminal equipment and the destination terminal equipment.

12. An apparatus for transmitting data, configured in a source terminal equipment, the apparatus comprising:
processor circuitry configured to determine a second egress RLC (Radio Link Control) channel to which a destination terminal equipment corresponds, wherein RBs towards the same destination terminal equipment and/or different destination terminal equipments being supported to be multiplexed to same second egress RLC channel; and
a transmitter configured to transmit via the determined second egress RLC channel to a relay terminal equipment, a data packet that is transmitted by the source terminal equipment to destination terminal equipments, the data packet comprising data transmitted by the source terminal equipment to the destination terminal equipment.

13. The apparatus according to claim 12, wherein that the processor circuitry determines a second egress RLC channel to which a destination terminal equipment corresponds comprises:
determining a second egress RLC channel with which an RB of the destination terminal equipment is associated.

14. The apparatus according to claim 12, wherein that the processor circuitry determines a second egress RLC channel with which an RB of the destination terminal equipment is associated comprises:
determining a second egress RLC channel to which the destination terminal equipment corresponds according to third configuration information, the third configuration information comprising the second egress RLC channel with which the RB of the destination terminal equipment is associated, or the RB of the destination terminal equipment with which the second egress RLC channel is associated.

15. The apparatus according to claim 12, wherein the third configuration information is from a network device.
